(19) United States
(12) Patent Application Publication
(10) Pub. No.: US 2026/0104670 A1
(43) Pub. Date: Apr. 16, 2026

(54) PROCESSING CARTRIDGE

(71) Applicant: Zhuhai Ninestar Information Technology Co. , Ltd, Zhuhai (CN)

(72) Inventors: Qin LUO, Zhuhai (CN); Hao DENG, Zhuhai (CN); Yinghao LI, Zhuhai (CN); Wenjun YU, Zhuhai (CN); Jialu YU, Zhuhai (CN); Roujuan CHEN, Zhuhai (CN); Linyuan DENG, Zhuhai (CN); Xiaoming LIANG, Zhuhai (CN); Likun ZENG, Zhuhai (CN)

(21) Appl. No.: 19/422,867

(22) Filed: Dec. 17, 2025

Related U.S. Application Data
(63) Continuation of application No. PCT/CN2024/101662, filed on Jun. 26, 2024.

(30) Foreign Application Priority Data
Jun. 27, 2023 (CN) 202321660819.1
Aug. 9, 2023 (CN) 202322147073.0
Aug. 16, 2023 (CN) 202322210524.0
Aug. 31, 2023 (CN) 202322366710.3
Nov. 9, 2023 (CN) 202323040340.0
Dec. 27, 2023 (CN) 202323603214.1

(51) Int. Cl. G03G 21/18

(52) U.S. Cl. CPC G03G 21/1825; G03G 21/1814; G03G 21/1842; G03G 2221/1654; G03G 2221/1861

(57) ABSTRACT

A processing cartridge is able to detachably mounted in an electronic imaging device, and includes a drum unit, including a photosensitive frame, on which a photosensitive drum is rotatably supported; and a developing unit, including a developing frame, on which a developing roller is rotatably supported. The developing unit is pivotally connected to the drum unit, and is able to move between a contact position and a separation position around a rotation axis relative to the drum unit. The processing cartridge further includes a control structure configured to limit the movement of the developing unit along a separation direction under the action of the self-gravity of the developing unit, so that the processing cartridge may not separate the drum and roller under the self-gravity of the developing unit.

### CROSS-REFERENCE TO RELATED APPLICATIONS

This application is a continuation of International Application No. PCT/CN2024/101662, filed on Jun. 26, 2024, which claims priority of Chinese Patent Application No. 202321660819.1 filed on Jun. 27, 2023, Chinese Patent Application No. 202322210524.0 filed on Aug. 16, 2023, Chinese Patent Application No. 202322147073.0 filed on Aug. 9, 2023, Chinese Patent Application No. 202322366710.3 filed on Aug. 31, 2023, Chinese Patent Application No. 202323040340.0 filed on Nov. 9, 2023, and Chinese Patent Application No. 202323603214.1 filed on Dec. 27, 2023, the entire content of each of which is hereby incorporated by reference.

### TECHNICAL FIELD

The present application relates to the technical field of image forming device, and in particular to a processing cartridge.

### BACKGROUND

An electronic imaging device forms an image on a recording material (such as paper) using an electronic photographic imaging process. Examples of electronic imaging devices include electronic photographic copiers, electronic photographic printers, fax machines, word processors, and the like. A cartridge includes at least one of an electronic photographic photosensitive drum as a photosensitive member and a developing member (such as a developing roller) that may act on the drum, where the photosensitive member and the developing member may also be integrally constructed as a cartridge (which may be referred to as a processing cartridge) that may be detachably mounted in the electronic imaging device. In the processing cartridge, a frame including the photosensitive member is a photosensitive frame, and a frame including the developing member is a developing frame.

During the operation of the electronic imaging device, the developing roller contacts and presses the photosensitive drum, so that the developer on the developing roller is transferred to the surface of the photosensitive drum forming a specific electrostatic latent image to complete the development process. However, when the developing roller contacts the photosensitive drum during the stoppage of the electronic imaging device, the developer carried on the developing roller is unnecessarily deposited on the photosensitive drum, and such developer is deposited on the recording material, resulting in the contamination of the recording material. Due to the long-term friction between the photosensitive drum and the developing roller, the deterioration of the developing roller and/or the developer is accelerated. Regardless of whether an elastic layer is provided on the surface of the developing roller, the above problems may still occur. Therefore, in order to solve the above technical problems, it is necessary to separate the photosensitive drum from the developing roller during the period when the electronic imaging device is not performing the development work, so as to extend the service life of the photosensitive drum and the developing roller. The processing cartridge of the existing technologies relies on the gravity of the developing frame to separate. During the separation process, since the gravity of the toner in the developing frame changes with the amount of toner used, the difficulty of separation by relying on the self-gravity of the developing frame changes, and the speed and stability of the drum-roller separation will be affected by the reduction of the residual toner. At the same time, when the residual toner in the processing cartridge is large, the mass of the developing box is large, which causes rigid collision between structures when separating by the self-gravity of the developing unit, which will cause wear and even damage to the processing cartridge components in the long run.

### SUMMARY

According to one aspect of the present disclosure, there is provided a processing cartridge that is detachably mounted in an electronic imaging device, and the processing cartridge includes: a drum unit, including a photosensitive frame, on which a photosensitive drum is rotatably supported, and the photosensitive drum extends along a first direction; a developing unit, including a developing frame, on which a developing roller is rotatably supported, and the developing roller extends along the first direction. The developing unit is pivotally connected to the drum unit, and the developing unit is able to move around a rotation axis relative to the drum unit between a first position and a second position, when in the first position, the developing roller is in contact with the photosensitive drum, and when in the second position, the developing roller is separated from the photosensitive drum. The direction of movement from the first position to the second position is the separation direction, and the direction of movement from the second position to the first position is the contact direction. The processing cartridge further includes a control structure configured to limit the movement of the developing unit along the separation direction under the action of the self-gravity.

Other aspects of the present disclosure may be understood by those skilled in the art in light of the description, the claims, and the drawings of the present disclosure.

### BRIEF DESCRIPTION OF THE DRAWINGS

In order to more thoroughly illustrate the technical solutions of the embodiments of the present disclosure, the drawings essential for understanding the embodiments will be briefly introduced hereinafter. Apparently, the drawings described below are merely some embodiments of the present disclosure. For a person skilled in the art, other drawings may be obtained based on these drawings without making creative efforts.

FIG. 1 is a schematic diagram of the overall structure of a processing cartridge according to Embodiment 1 of the present disclosure;

FIG. 2 is a schematic diagram of the exploded structure of a processing cartridge according to Embodiment 1 of the present disclosure;

FIG. 3 is a schematic structural diagram of a non-driving end of a processing cartridge according to Embodiment 1 of the present disclosure;

FIG. 4 is a schematic side view of the structure of a processing cartridge according to Embodiment 1 of the present disclosure;

FIG. 5 is a schematic diagram of the overall structure of a processing cartridge according to Embodiment 2 of the present disclosure;

FIG. 6 is a schematic diagram of the exploded structure of a processing cartridge according to Embodiment 2 of the present disclosure;

FIG. 7 is a schematic structural diagram of a drum unit according to Embodiment 2 of the present disclosure;

FIG. 8 is a partially enlarged schematic diagram of point A in FIG. 7;

FIG. 9 is a schematic diagram of a partial structure of a developing unit according to Embodiment 2 of the present disclosure;

FIG. 10 is a schematic structural diagram of a side of a processing cartridge according to Embodiment 2 of the present disclosure;

FIG. 11 is another schematic structural diagram of a side of a processing cartridge according to Embodiment 2 of the present disclosure;

FIG. 12 is a side-sectional view of a processing cartridge according to Embodiment 2 of the present disclosure.

FIG. 13 is a schematic structural diagram of a processing cartridge according to Embodiment 3 of the present disclosure;

FIG. 14 is a structural exploded view of a processing cartridge according to Embodiment 3 of the present disclosure;

FIG. 15 is a schematic structural diagram of a drum unit according to Embodiment 3 of the present disclosure;

FIG. 16 is a schematic structural diagram of a developing unit after opening a developing frame according to Embodiment 3 of the present disclosure;

FIG. 17 is a schematic structural diagram of a driving end of a processing cartridge according to Embodiment 3 of the present disclosure;

FIG. 18 is a schematic structural diagram of a separator according to Embodiment 3 of the present disclosure;

FIG. 19 is a schematic structural diagram of a developing end cover according to Embodiment 3 of the present disclosure;

FIG. 20 is a schematic diagram of a matching portion of a separator and a developing end cover according to Embodiment 3 of the present disclosure;

FIG. 21 is a schematic diagram of an abutment member and a developing drive head after being separated according to Embodiment 3 of the present disclosure;

FIG. 22 is a side view of a drum-roller separated processing cartridge according to Embodiment 3 of the present disclosure;

FIG. 23 is a schematic structural diagram of a driving end of a processing cartridge according to Embodiment 4 of the present disclosure;

FIG. 24 is a schematic structural diagram of a separator according to Embodiment 4 of the present disclosure;

FIG. 25 is a schematic structural diagram of a processing cartridge according to Embodiment 4 of the present disclosure;

FIG. 26 is a partially enlarged schematic diagram of point B in FIG. 25;

FIG. 27 is a schematic diagram of an engagement between a separation control member and an abutment slope according to Embodiment 4 of the present disclosure;

FIG. 28 is a schematic diagram of a separation control member and an abutment slope after separation according to Embodiment 4 of the present disclosure;

FIG. 29 is a side view of a drum-roller separated processing cartridge according to Embodiment 4 of the present disclosure;

FIG. 30 is a schematic structural diagram of a processing cartridge according to Embodiment 5 of the present disclosure;

FIG. 31 is a disassembled structural view of a processing cartridge according to Embodiment 5 of the present disclosure;

FIG. 32 is a schematic structural diagram of a drum unit according to Embodiment 5 of the present disclosure;

FIG. 33 is a schematic diagram of a developing unit after opening a developing frame according to Embodiment 5 of the present disclosure;

FIG. 34 is a schematic structural diagram of a driving end according to Embodiment 5 of the present disclosure;

FIG. 35 is a side view of a processing cartridge according to Embodiment 5 of the present disclosure;

FIG. 36 is a partially enlarged schematic diagram of point C in FIG. 35;

FIG. 37 is a schematic structural diagram of a driving end according to Embodiment 6 of the present disclosure;

FIG. 38 is a partially enlarged schematic diagram of point D in FIG. 37;

FIG. 39 is a side view of a processing cartridge according to Embodiment 7 of the present disclosure;

FIG. 40 is a partially enlarged schematic diagram of point E in FIG. 39;

FIG. 41 is a side view of a processing cartridge according to Embodiment 8 of the present disclosure;

FIG. 42 is a schematic diagram of the overall structure of a processing cartridge from one angle according to Embodiment 9 of the present disclosure;

FIG. 43 is a schematic diagram of the overall structure of a processing cartridge from another angle according to Embodiment 9 of the present disclosure;

FIG. 44 is a schematic structural diagram of a processing cartridge when it is not placed in an electronic imaging device according to Embodiment 9 of the present disclosure;

FIG. 45 is a schematic structural diagram of a processing cartridge after being placed in an electronic imaging device according to Embodiment 9 of the present disclosure;

FIG. 46 is a schematic structural diagram of a pressing member of a processing cartridge according to Embodiment 9 of the present disclosure;

FIG. 47 is a schematic diagram of the overall structure of a processing cartridge according to Embodiment 10 of the present disclosure;

FIG. 48 is a cross-sectional schematic diagram of a processing cartridge according to Embodiment 10 of the present disclosure;

FIG. 49 is a schematic diagram of the exploded structure of a processing cartridge according to Embodiment 10 of the present disclosure;

FIG. 50 is a schematic diagram of a partial structure of one end of a processing cartridge in a length direction according to Embodiment 10 of the present disclosure;

FIG. 51 is a structural diagram and a partially enlarged diagram of a processing cartridge according to Embodiment 10 of the present disclosure;

FIG. 52 is a schematic structural diagram of a developing unit according to Embodiment 10 of the present disclosure; and

FIG. 53 is a schematic diagram of the partial structure of a developing unit according to Embodiment 10 of the present disclosure.

### DETAILED DESCRIPTION

The present disclosure is further described in detail below in conjunction with the accompanying drawings. Apparently, the described embodiments are merely part of the embodiments of the present disclosure, not all of the embodiments. Based on the embodiments of the present disclosure, all other embodiments obtained by a person skilled in the art without making creative efforts are within the scope of protection of the present disclosure.

It should be noted that the terms “first”, “second”, etc., are just used for descriptive purposes and should not be understood as indicating or implying relative importance or implicitly indicating the number of the indicated technical features.

Therefore, the features defined as “first” or “second” may explicitly or implicitly include at least one of the features. In the description of the present disclosure, the meaning of “plurality” is at least two, such as two, three, etc., unless otherwise clearly and specifically defined.

In the present disclosure, unless otherwise clearly specified and limited, the terms “installation”, “connection”, “fixation” and the like should be understood in a broad sense. For example, a connection may be a fixed connection, a detachable connection, or an integral one, or may be a mechanical connection, an electrical connection, or communication with each other. A connection may be a direct connection, or an indirect connection through an intermediate medium, or may be the internal connection of two elements or the interaction relationship between two elements, unless otherwise clearly defined. For a person skilled in the art, the specific meanings of the above terms in the present disclosure may be understood according to specific circumstances.

In the present disclosure, unless otherwise clearly specified and limited, a first feature being “above” or “below” a second feature may mean that the first and second features are in direct contact, or the first and second features are in indirect contact through an intermediate medium. Moreover, a first feature being “over”, “upon” or “above” a second feature may mean that the first feature is directly above or obliquely above the second feature, or simply means that the first feature is higher in level than the second feature. A first feature being “below”, “under” or “underneath” a second feature may mean that the first feature is directly below or obliquely below the second feature, or simply means that the first feature is lower in level than the second feature.

In the present disclosure, the description with reference to the terms “one embodiment”, “some embodiments”, “example”, “specific example”, or “some examples” etc., means that the specific features, structures, materials or characteristics described in conjunction with the embodiments or examples are included in at least one embodiment or example of the present disclosure. In this specification, the schematic representations of the above terms do not necessarily refer to the same embodiment or example. Moreover, the specific features, structures, materials or characteristics described may be combined in any one or more embodiments or examples in a suitable manner. In addition, those skilled in the art may combine and combine the different embodiments or examples described in this specification and the features of the different embodiments or examples, without contradiction.

The following descriptions of the directions are as follows:

The directions A1 and A2 are the first directions, the direction indicated by A1 is the positive side of the first direction, and the direction indicated by A2 is the negative side of the first direction.

The directions B1 and B2 are the second direction, the direction indicated by B1 is the positive side of the second direction, and the direction indicated by B2 is the negative side of the second direction.

The directions of C1 and C2 are the third direction, the direction pointed by C1 is the positive side of the third direction, and the direction pointed by C2 is the negative side of the third direction.

The first direction, the second direction and the third direction intersect each other.

An electronic imaging device uses, for example, an electronic photographic imaging process to form an image on a recording material. The electronic imaging device includes, for example, an electronic photographic copier, an electronic photographic printer (such as an LED printer, a laser printer, etc.), an electronic photographic printer-type fax machine, etc. A processing cartridge is detachably mounted in the electronic imaging device, and the processing cartridge includes a photosensitive drum 220, a developing roller for developing an electrostatic latent image formed on the photosensitive drum 220, etc. The electronic imaging device includes a drive head, and the drive head is used to transmit the driving force of the electronic imaging device to the processing cartridge to make the processing cartridge work. The electronic imaging device also includes a force-applying member 900.

### Embodiment 1

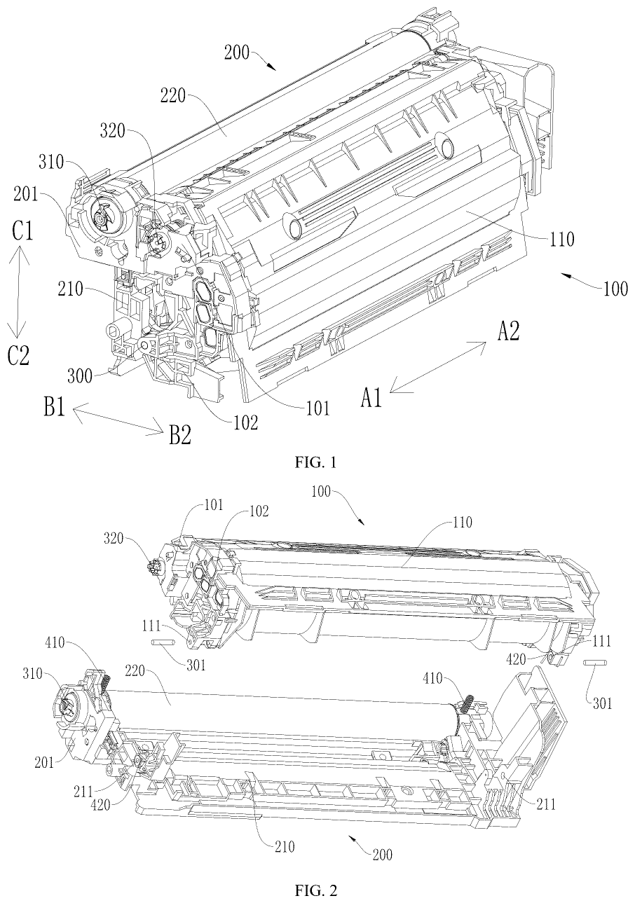

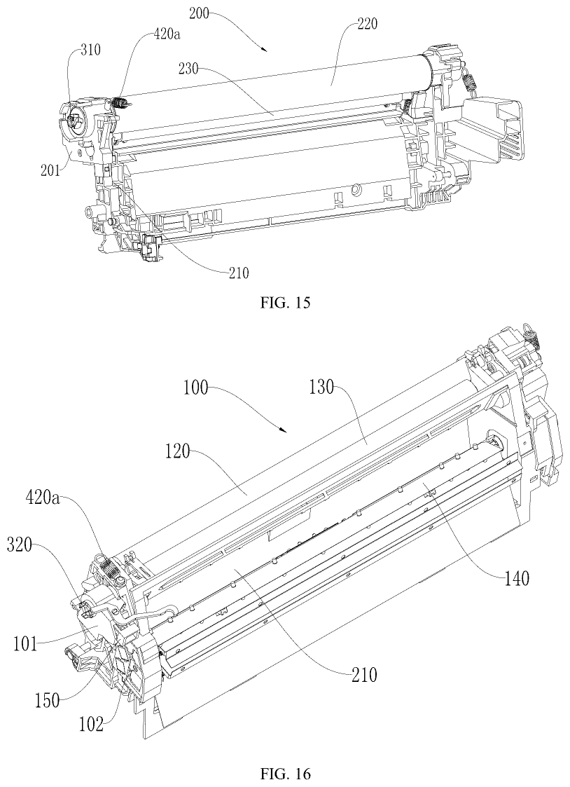

As shown in FIG. 1, Embodiment 1 provides a processing cartridge detachably mounted on an electronic imaging device, and the processing cartridge includes a developing unit 100, a drum unit 200 and a driving assembly. The developing unit 100 includes a developing frame 110, a developing roller, a powder feeding roller, a stirring frame and a powder discharge blade. The drum unit 200 includes a photosensitive frame 210, a photosensitive drum 220, a charging roller 230 (shown in FIG. 15) and a cleaning blade. The processing cartridge is generally in the shape of a rectangular box, which has a length in the first direction (i.e., A1 and A2 directions), a width in the second direction (i.e., B1 and B2 directions), and a height in the third direction (i.e., C1 and C2 directions). The developing unit 100 and the drum unit 200 are disposed opposite to each other in the second direction, where the direction from the developing unit 100 to the drum unit 200 is the B1 direction. One end of the processing cartridge along the C1 direction is the upper end, and one end along the C2 direction is the lower end. The photosensitive drum 220 is disposed at the upper end of the drum unit 200, and the developing roller is disposed at the upper end of the developing unit 100. One end of the processing cartridge along the B1 direction is the front end, and one end along the B2 direction is the rear end. One end of the processing cartridge along the A1 direction is the driving end, and one end along the A2 direction is the non-driving end.

As shown in FIG. 1, the length direction of the developing frame 110 extends along the first direction. The developing frame 110 includes a powder bin, a developing bearing 102 and a developing end cover 101. The powder bin is used to contain carbon powder. The powder bin is roughly in the shape of a long box. The developing frame 110 is provided with a developing bearing 102 supporting a developing roller, a powder feeding roller and a stirring frame at both ends of the length direction. The developing end cover 101 is disposed on the outside of the developing bearing 102 to protect the driving assembly located on the outside of the developing bearing 102. The developing roller, the powder feeding roller and the stirring frame rotate under the action of the driving assembly. The axial directions of the developing roller, the powder feeding roller and the stirring frame are all along the length direction (i.e., first direction) of the developing frame 110. The carbon powder in the powder bin is stirred by the stirring frame to prevent the carbon powder in the powder bin from agglomerating. At the same time, the carbon powder may also be transported along the direction of the powder feeding roller. The powder feeding roller transports the carbon powder to the developing roller and is adsorbed by the charged developing roller.

As shown in FIG. 1, the photosensitive frame 210 also has a length direction, which is consistent with the length direction of the developing frame 110 (e.g., both along the A1 and A2 directions). Photosensitive end covers 201 supporting the photosensitive drum 220 are provided at both ends of the photosensitive frame 210 in the first direction.

The toner adsorbed by the developing roller is transferred to the photosensitive drum 220 through the potential difference between the developing roller and the photosensitive drum 220. The toner on the photosensitive drum 220 is then transferred by the transfer belt of the electronic imaging device to form an image on the recording material (such as paper). The charging roller 230 (shown in FIG. 15) is used to charge the surface of the photosensitive drum 220 with a uniform charge, so that the photosensitive drum 220 can adsorb the toner.

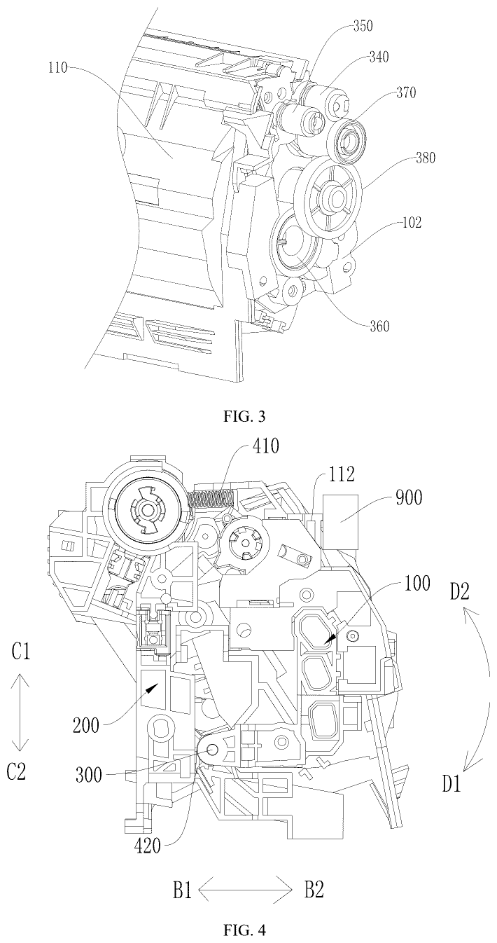

As shown in FIGS. 1 and 3, the driving assembly includes a photosensitive coupling 310, a developing coupling 320, a developing roller gear 340, a powder feeding roller gear 350, a stirring frame gear 360, a first idler gear 370, and a second idler gear 380. The driving assembly may be disposed at one end and/or both ends of the processing cartridge in the first direction (i.e., length direction). Specifically, the photosensitive coupling 310 is disposed at one end (preferably the driving end/the end in the A1 direction) of the photosensitive drum 220 in the length direction, and is configured to engage with the photosensitive drive head of the electronic imaging device to receive the driving force and drive the photosensitive drum 220 to rotate. The developing coupling 320 is disposed at the driving end of the developing frame 110 and is located on the outside of the developing bearing 102. The developing coupling 320 is sleeved on a part of the shaft of the powder feeding roller extending from the developing bearing 102. A developing end cover 101 is provided with an opening for exposing the developing coupling 320. The developing coupling 320 engages with the developing drive head of the electronic imaging device and receives the driving force. The developing roller gear 340, the powder feeding roller gear 350, the stirring frame gear 360, the first idler gear 370, and the second idler gear 380 are disposed at the non-driving end (i.e., the end in the A2 direction) of the developing frame 110. The developing roller gear 340, the powder feeding roller gear 350, and the stirring frame gear 360 are respectively sleeved on the parts of the developing roller, the powder feeding roller, and the stirring frame shaft extending out of the developing bearing 102 at the non-driving end (i.e., the end in the A2 direction). The developing roller gear 340 and the powder feeding roller gear 350 are meshed with the first idler gear 370, and the first idler gear 370 is meshed with the second idler gear 380, and the second idler gear 380 is meshed with the stirring frame gear 360. The developing coupling 320 receives the driving force to drive the powder feeding roller to rotate, and the powder feeding roller gear 350 rotates synchronously. The developing roller gear 340 and the stirring frame gear 360 are directly or indirectly meshed with the powder feeding roller gear 350, so that the developing coupling 320 transmits the received driving force, thereby driving the developing roller, the powder feeding roller and the stirring frame to rotate.

During the operation of the electronic imaging device, the developing roller and the photosensitive drum 220 need to be in close contact. When the electronic imaging device is not working, the developing roller and the photosensitive drum 220 need to be separated by a certain distance to avoid long-term contact between the developing roller and the photosensitive drum 220, which may cause the photosensitive drum 220 to be contaminated by excess developer attached to the developing roller, or the developing roller may be deformed or the photosensitive drum 220 may be worn.

As shown in FIGS. 1 to 4, based on the above, the drum unit 200 and the developing unit 100 in Embodiment 1 are configured to be able to move relative to each other, so that the developing roller and the photosensitive drum 220 may be in contact when the electronic imaging device is working and separated when not working. In the disclosed embodiment, the developing unit 100 and the drum unit 200 are pivotally connected.

Specifically, the drum unit 200 and the developing unit 100 are pivotally connected with the connecting part 300 as the center, and the central axis of the connecting part 300 defines the axis (i.e., rotation axis/swinging center) of the developing unit 100 relative to the drum unit 200. The connecting part 300 includes a connecting member 301 and a pivoting portion, and the pivoting portion includes a first pivot hole 211 provided on the photosensitive frame 210 and a second pivot hole 111 provided on the developing frame 110. The connecting member 301 passes through the first pivot hole 211 and the second pivot hole 111 in sequence to pivot the photosensitive frame and the developing frame. Two first pivot holes 211 are respectively disposed at the two ends of the photosensitive frame 210 in the first direction, and two second pivot holes 111 are respectively disposed at the two ends of the developing frame 110 in the first direction (specifically, these holes may be opened on the developing bearings 102 at the two ends). There are two connecting members 301, which are respectively pivotally connected to the first pivot holes 211 and the second pivot holes 111 located at the two ends in the first direction. The connecting members 301 are disposed at the two ends of the processing cartridge in the first direction, and there are two connecting members 301. Specifically, the connecting members 301 may be components such as screws or pins. In the disclosed embodiment, a connecting part is located directly below the developing roller. When viewed along the third direction, the rotation axis of the developing unit 100 swinging relative to the drum unit 200 is located within the projection range of the developing roller. In the second direction, the connecting part is approximately located in the middle of the processing cartridge.

When the processing cartridge is removed from the electronic imaging device, the posture of the drum unit 200 is a removal posture (e.g., the posture shown in FIG. 3). When the drum unit 200 is in the removal posture, the developing unit 100 may move between a first position and a second position relative to the drum unit 200 along the rotation axis. As shown in FIG. 3, at the first position, the developing roller contacts the photosensitive drum 220, and at the second position, the developing roller is separated from the photosensitive drum 220. The direction in which the developing unit 100 rotates relative to the drum unit 200 around the rotation axis includes a separation direction D1 and a contact direction D2 opposite to the separation direction D1. The developing unit 100 rotates from the first position to the second position along the separation direction D1, and the separation direction D1 is clockwise when viewed from the angle of FIG. 4. The developing unit 100 rotates from the second position to the first position along the contact direction D2, and the contact direction D2 is counterclockwise when viewed from the angle of FIG. 3.

When the drum unit 200 is in the removal posture, the developing unit 100 has a tendency to move toward the second position along the separation direction D1 under the action of its self-gravity. That is, its self-gravity may cause the developing unit 100 to rotate to the second position along the separation direction D1.

As shown in FIGS. 1 to 4, in the disclosed embodiment, the processing cartridge also includes a control structure for limiting the movement of the developing unit along the separation direction D1 under the action of its self-gravity. Specifically, the control structure in the disclosed embodiment is a second type of elastic member 420, and the second type of elastic member 420 is disposed between the photosensitive frame 210 and the developing frame 110. When the drum unit 200 is in a removal posture, the second type of elastic member 420 may offset the self-gravity of the developing unit that causes the developing unit 100 to move to the second position, thereby limiting the movement of the developing unit 100 along the separation direction under the action of its self-gravity. That is, the self-gravity of the developing unit 100 may not cause the developing unit 100 to rotate along the separation direction D1, thereby maintaining the first position. Specifically, the second type of elastic member 420 includes at least one torsion spring. In some embodiments, the number of torsion springs is two. That is, the second type of elastic member 420 is disposed near the rotation axis in the third direction. In some embodiments, the loop portion of the torsion spring is disposed coaxially with the rotation axis, and the loop portion may be sleeved on the first pivot hole 211 of the photosensitive frame 210 or the second pivot hole 111 of the developing frame 110 or sleeved on the connecting member 301. One arm of the torsion spring abuts against the photosensitive frame 210, and the other arm abuts against the developing frame 110. When the drum unit 200 is in the removal posture, the torsion spring is in a compressed/torsional state, and the force of the torsion spring on the developing unit 100 is along the contact direction D2 opposite to the separation direction D1. That is, the torsion spring has a force to rotate the developing unit 100 in the counterclockwise direction, and the force of the torsion spring is greater than or equal to the self-gravity of the developing unit 100, thereby offsetting the self-gravity of the developing unit 100. That is, the self-gravity of the developing unit may not cause the developing unit 100 to rotate to the second position along the separation direction D1.

As shown in FIGS. 1 to 4, after the second type of elastic member 420 offsets the gravity, the developing unit 100 may not move to the second position under the gravity, so that the developing roller is separated from the photosensitive drum 220. Therefore, in the disclosed embodiment, the processing cartridge is also provided with a separator for providing a force to move the developing unit 100 from the first position to the second position. In the disclosed embodiment, the separator is a first type of elastic member 410, which is disposed between the photosensitive frame 210 and the developing frame 110. The first type of elastic member 410 includes at least one compression spring, and the elastic expansion direction of the compression spring extends along the second direction. One end of the compression spring abuts against the photosensitive frame 210, and the other end abuts against the developing frame 110. The second type of elastic member 420 is disposed at the upper end of the processing cartridge in the third direction, that is, close to the photosensitive drum 220. In some embodiments, there are two first type of elastic members 410, which are respectively disposed at the two ends of the photosensitive frame 210 and the developing frame 110 in the first direction. The photosensitive frame 210 and the developing frame 110 may be provided with connecting structures such as protrusions/grooves for connecting the first type of elastic members 410.

The force of the first type of elastic member 410 on the developing unit 100 causes the developing unit 100 to rotate around the rotation axis along the separation direction D1. That is, the force of the first type of elastic member 410 on the developing unit 100 is in the clockwise direction, and the developing unit 100 rotates from the first position to the second position along the separation direction D1. The combined force of the force of the second type of elastic member 420 and the self-gravity of the developing unit 100 is greater than or equal to zero, and the force of the first type of elastic member 410 is greater than the combined force of the force of the second type of elastic member 420 and the self-gravity of the developing unit, which may ensure that the developing unit 100 may rotate to the second position, and ensure that the photosensitive drum 220 and the developing roller may be stably separated.

A force-bearing part 112 is also provided on the developing unit 100 for receiving a contact force applied by the force-applying member 900 of the electronic imaging device. The force-bearing part 112 is a protruding structure disposed on the developing frame 110. The force-bearing part 112 is disposed near the upper end of the developing frame 110 in the third direction. The force-bearing part 112 may be disposed at one end or both ends of the developing frame 110 in the length direction.

As shown in FIGS. 1 to 4, when the processing cartridge is mounted in the electronic imaging device but no development work is performed, the drum unit 200 is in a removal posture. Since the force of the first type of elastic member 410 is greater than the combined force of the force of the second type of elastic member 420 and the self-gravity of the developing unit 100, the developing unit 100 rotates to the second position and remains in the second position under the action of the first type of elastic member 410, and the developing roller and the photosensitive drum 220 are kept in a separated state. At this time, the second type of elastic member 420 is in a compressed state due to offsetting the self-gravity of the developing unit.

As shown in FIGS. 1 to 4, when developing work is required, the force-applying member 900 of the electronic imaging device moves in the direction of B1, and after contacting the force-bearing part 112, a contact force along the direction of B1 is applied to the force-bearing part 112, and the contact force acts on the entire developing unit 100. Under the action of the contact force, the force of the first type of elastic member 410 is overcome, so that the first type of elastic member 410 is compressed and deformed, and the developing unit 100 rotates from the second position to the first position around the rotation axis along the contact direction D2 (i.e., counterclockwise). The upper end of the developing unit 100 moves in the direction close to the photosensitive drum 220, and the developing roller contacts the photosensitive drum 220, and the two arms of the second type of elastic member 420 return to the original state or the stretched state. At this time, the contact force and the combined force of the force of the second type of elastic member 420 and the self-gravity of the developing unit 100 are greater than the force of the first type of elastic member 410, and the developing roller maintains a contact state with the photosensitive drum 220, and the developing work may be performed.

As shown in FIGS. 1 to 4, when the developing work is completed, the force-applying member 900 of the electronic imaging device moves in the direction of B2. The contact force is removed, and the elastic deformation of the first type of elastic member 410 is restored, pushing the developing unit 100 to rotate from the first position to the second position around the rotation axis along the separation direction D1 (i.e., clockwise direction). The upper end of the developing unit 100 moves in the direction away from the photosensitive drum 220, the developing roller is separated from the photosensitive drum 220, and the second type of elastic member 420 is compressed. Since the force of the first type of elastic member 410 is greater than the combined force of the force of the second type of elastic member 420 and the self-gravity of the developing unit 100, the processing cartridge remains in a state of separation between the drum and the roller, waiting for a next developing work to start or the processing cartridge to be removed from the electronic imaging device.

The processing cartridge of the disclosed embodiment is provided with two types of elastic members between the developing frame 110 and the photosensitive frame 210, where the force provided by the first type of elastic member 410 enables the processing cartridge to complete the drum-roller separation process to ensure the stability of the separation process, while the force provided by the second type of elastic member 420 offsets the self-gravity of the developing frame 110. When the force-applying component in the printer removes the thrust on the developing frame 110, due to the action of the second type of elastic member 420, the separation of the developing frame 110 is merely due to the action of the first type of elastic member 410. This then alleviates the impact between the contact structure of the developing frame 110 and the photosensitive frame 210, thereby prolonging the service life of the processing cartridge. In addition to the one compression spring and one torsion spring provided in the disclosed embodiment, the first type of elastic member and the second type of elastic member of the disclosed embodiment may also be two tension springs with different tensions, two compression springs with different compression degrees, etc., and the first type of elastic member may also be a tension spring, a torsion spring, etc.

### Embodiment 2

Embodiment 2 provides another processing cartridge. Compared with Embodiment 1, the difference lies in the control structure. The connecting part in Embodiment 1 is omitted, and the control structure is used instead of the connecting part to pivotally connect the developing unit 100 and the drum unit 200.

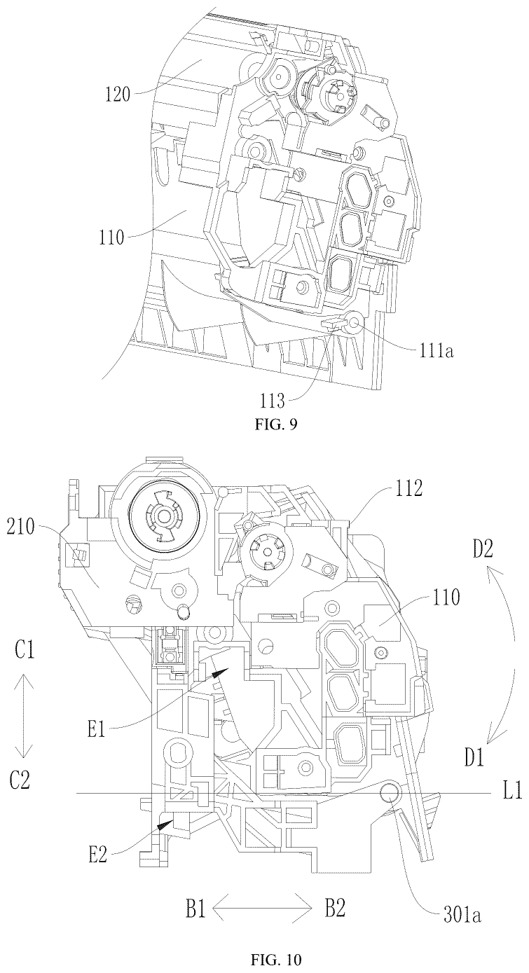

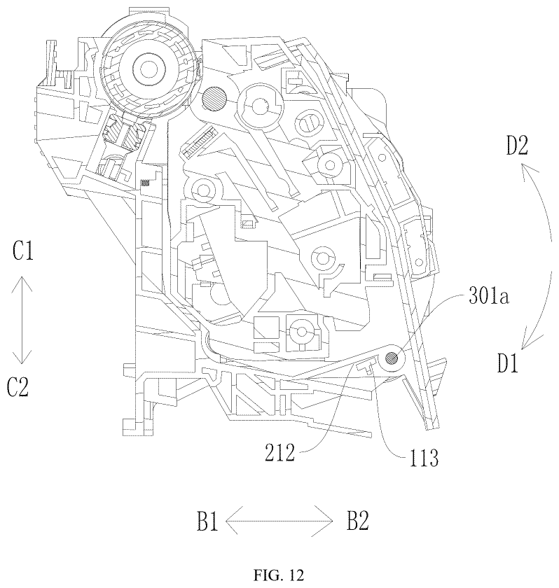

As shown in FIGS. 5 to 12, in the disclosed embodiment in Embodiment 2, the control structure includes a connecting member 301a and a pivoting portion, and the pivoting portion includes a first pivot hole 211a provided on the photosensitive frame 210 and a second pivot hole 111a provided on the developing frame 110. The connecting member 301a passes through the first pivot hole 211a and the second pivot hole 111a in sequence and then pivots the photosensitive frame and the developing frame. That is, the centers of the connecting member 301a, the first pivot hole 211a and the second pivot hole 111a coincide, and the central axis of the three is the central axis of the control structure, and is also the rotation axis of the developing unit 100 swinging relative to the drum unit 200. The control structure is identical to the structure of the connecting part 300 of Embodiment 1, and just the position of the control structure on the processing cartridge is different.

As shown in FIGS. 5, 6, 10 to 12, in the disclosed embodiment, the control structure is located on the rear side of the developing roller 120 in the second direction (i.e., on the side in the B2 direction). The control structure is disposed at a position close to the end of the developing frame 110 along the separation direction (i.e., D1 direction) (i.e., close to the C2 direction/lower end of the developing frame 110). The developing roller 120 is located at one end of the developing frame 110 in the third direction (i.e., the end in the C1 direction). The control structure is close to the other end of the developing frame 110 in the third direction (i.e., the end in the C2 direction). That is, the axis of the control structure is located on the B2 and C2 directions (i.e., the rear lower side) of the axis of the developing roller 120. When viewed along the A2 direction, the central axis of the control structure does not overlap with the axis of the developing roller 120. When viewed along the third direction, the central axis of the control structure is located outside the projection range of the developing roller 120.

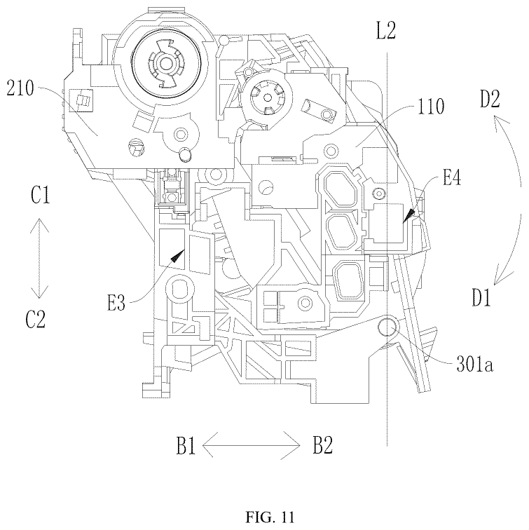

As shown in FIG. 10, when viewed along the A2 direction, a straight line passing through the center of the control structure and parallel to the second direction is defined as a first straight line L1. The first straight line L1 divides the processing cartridge into a first region E1 and a second region E2 in the third direction. The developing roller 120, the powder feeding roller and the photosensitive drum 220 are all located in the first region E1. The area of the first region E1 is larger than that of the second region E2.

As shown in FIG. 11, when reviewed along the A2 direction, a straight line passing through the center of the control structure and parallel to the third direction is defined as a second straight line L2. The second straight line L2 divides the processing cartridge into a third region E3 and a fourth region E4 in the second direction. The developing roller 120, the powder feeding roller and the photosensitive drum 220 are located in the third region E3. The area of the third region E3 is larger than that of the fourth region E4.

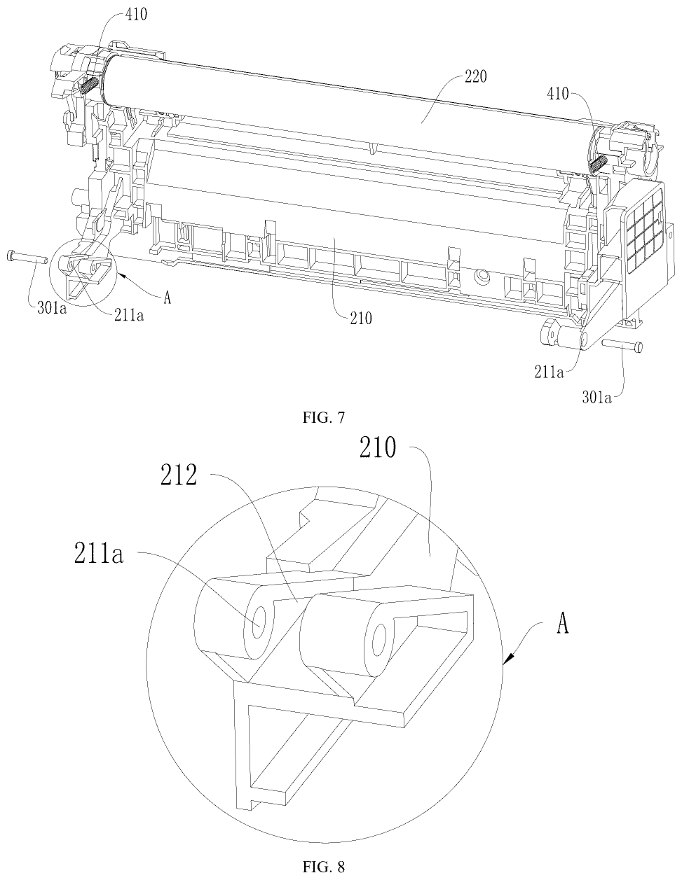

As shown in FIG. 7, in the disclosed embodiment, the processing cartridge is further provided with a separator (e.g., a first type of elastic member 410, which is identical to that in Embodiment 1) for providing a force for moving the developing unit 100 from the first position to the second position.

The force exerted by the first type of elastic member 410 on the developing unit 100 causes the developing unit 100 to rotate along the separation direction D1 around the axis (e.g., the rotation axis) of the control structure. That is, the force exerted by the first type of elastic member 410 on the developing unit 100 is in the clockwise direction, and the developing unit 100 rotates from the first position to the second position along the separation direction D1.

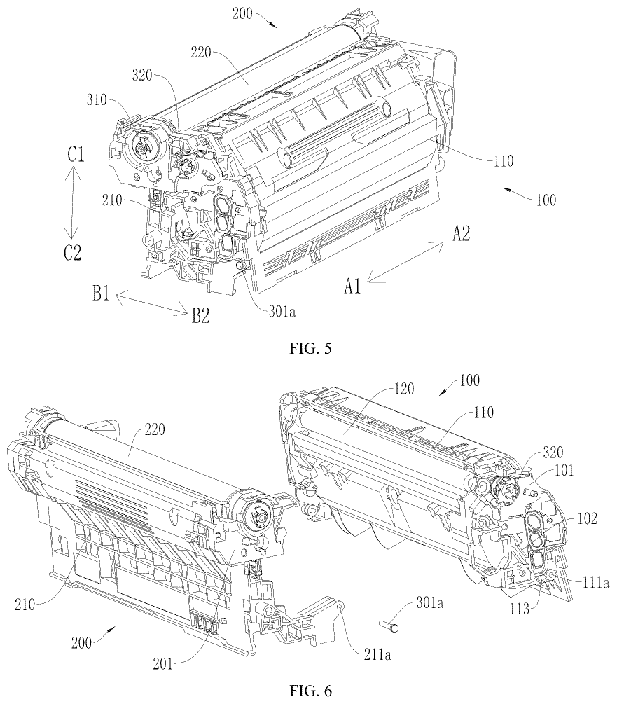

Further, as shown in FIGS. 6 to 9 and 12, a limiting part 212 is provided on the photosensitive frame 210, and a limited part 113 cooperating with the limiting part 212 is provided on the developing frame 110. The limiting part 212 cooperates with the limited part 113 to limit the swinging range of the developing unit 100 in the separation direction D1. Specifically, the limited part 113 is a protrusion provided on the side wall of the developing frame 110 at one end in the A1 direction, and the protrusion protrudes from the side wall of the developing frame 110 along the A1 direction. The limited part 113 is provided close to the control structure and is located on the positive side (i.e., the B1 direction) of the control structure in the second direction. The limiting part 212 is a groove portion formed on the photosensitive frame 210, and the protruding portion is located in the groove portion. The groove portion may be provided with groove walls at both the C1 and C2 directions, or may be provided with groove walls just at the C1 direction. When the developing unit 100 swings along the separation direction D1 until the limited part 113 abuts against the limiting part 212 (e.g., abuts against the groove wall at the C1 direction of the groove portion), the movement of the developing unit in the separation direction D1 is limited, and the developing unit 100 may not continue to move in the separation direction D1, thereby preventing the processing cartridge from being over-separated during the drum-roller separation.

As shown in FIGS. 5 to 12, when the processing cartridge is mounted in the electronic imaging device but no developing work is performed, the processing cartridge is maintained in the second position under the action of the first type of elastic member 410 (i.e., the separator), and the developing roller 120 and the photosensitive drum 220 remain in a separated state.

As shown in FIGS. 5 to 12, when developing work is necessary, the force-applying member of the electronic imaging device moves in the direction of B1, and after contacting the force-bearing part 112, a contact force along the direction of B1 is applied to the force-bearing part 112, and the contact force acts on the entire developing unit 100. Under the action of the contact force, the force of the first type of elastic member 410 is overcome, so that the first type of elastic member 410 is compressed and deformed, and the developing unit 100 rotates from the second position to the first position along the contact direction D2 (i.e., counterclockwise) around the axis of the control structure. The upper end of the developing unit 100 moves in the direction close to the photosensitive drum 220, and the developing roller 120 contacts and maintains a contact state with the photosensitive drum 220, so that developing work may be performed.

As shown in FIGS. 5 to 12, when the developing work is completed, the force-applying member of the electronic imaging device moves in the direction of B2, the contact force is removed, and the elastic deformation of the first type of elastic member 410 is restored, pushing the developing unit 100 to rotate from the first position to the second position along the separation direction D1 (i.e., clockwise) around the axis of the control structure. The upper end of the developing unit 100 moves in the direction away from the photosensitive drum 220, and the developing roller 120 is separated from the photosensitive drum 220. When the limited part 113 rotates with the developing frame 110 to abut against the limiting part 212, the rotational movement of the developing unit 100 stops, and the processing cartridge remains in a state of drum-roller separation under the action of the first type of elastic member 410, waiting for a next developing work to start or waiting for the processing cartridge to be removed from the electronic imaging device.

The control structure of the photosensitive frame 210 and the developing frame 110 of the processing cartridge of the disclosed embodiment is disposed at the end close to the developing frame 110 along the separation direction D1, so that the processing cartridge may not rely on its self-gravity to separate the drum and roller. The moving distance of the developing unit 100 when separating may be reduced. This solves the problems in the existing technologies (i.e., when the connecting part is disposed approximately in the middle of the processing cartridge, when there is a lot of residual toner in the processing cartridge, the mass of the developing unit 100 is large, and when separated, the moving distance of the developing unit 100 will be large, resulting in rigid collision between structures, which will cause wear and even damage to the processing cartridge parts in the long run), thereby ensuring the service life of the processing cartridge.

The other structures of the processing cartridge of Embodiment 2 are identical to those of Embodiment 1 and will not be described again.

### Embodiment 3

Embodiment 3 provides another processing cartridge, which is different from Embodiment 1 in that the control structure is different, the separator structure is different, and an abutment member is also provided.

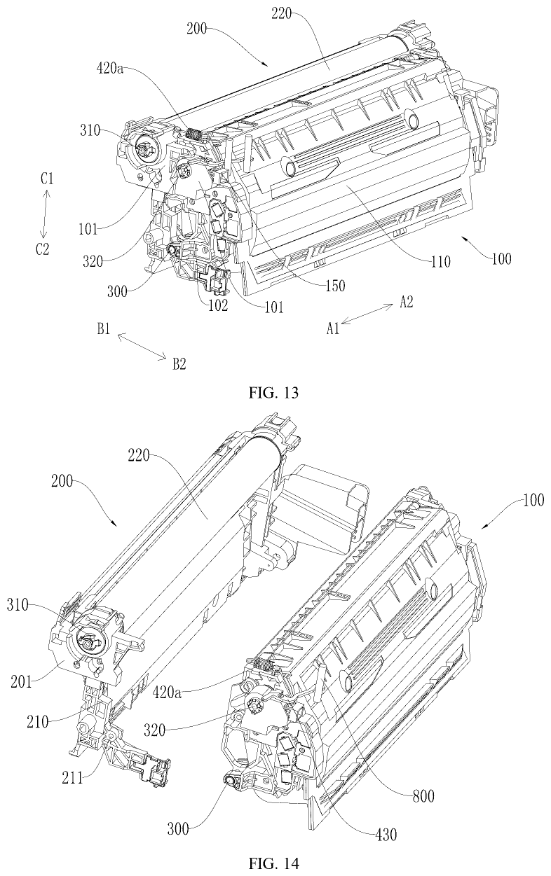

As shown in FIGS. 13 to 15, in the disclosed embodiment, in order to ensure that the developing roller 120 and the photosensitive drum 220 are continuously in contact during the developing operation, a control structure (e.g., a second type of elastic member 420a) is provided between the developing frame 110 and the photosensitive frame 210, which is used to limit the movement of the developing unit 100 along the separation direction D1 under the action of its self-gravity. The second type of elastic member 420a is located on the upper side of the processing cartridge (i.e., C1 direction). The second type of elastic member 420a uses a tension spring, and its two ends are respectively connected to the developing frame 110 and the photosensitive frame 210. The second type of elastic member 420a offsets the effect of the self-gravity of the developing unit 100, limits the movement of the developing unit 100 along the separation direction D1 under the action of its self-gravity, and keeps the developing unit 100 in the first position, and the developing roller 120 and the photosensitive drum 220 remain in contact.

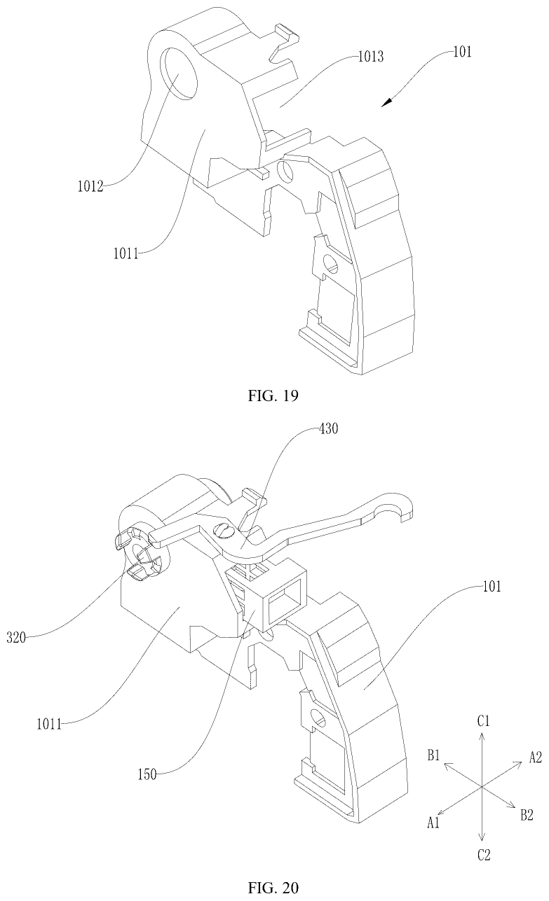

As shown in FIGS. 13 to 21, the abutment member 150 is slidably disposed at the driving end (i.e., the end in the A1 direction) of the developing unit 100, and may be specifically disposed on the developing end cover 101. The developing end cover 101 has a protruding portion 1011, and the interior of the protruding portion 1011 is a hollow structure. The protruding portion 1011 is provided with an opening 1012 and a slot 1013. The opening 1012 is located on the A1 side of the developing end cover 101, and is used for the developing coupling 320 to be telescopically moved on the developing end cover 101, so that the developing coupling 320 may be exposed from the opening 1012. The slot 1013 is located on the B2 side of the opening 1012, and is used to provide a space for the abutment member 150 to be inserted. The abutment member 150 may move in the slot 1013. The abutment member 150 is generally a rectangular body structure, and its B1 side is engaged with the developing coupling 320. Specifically, the circumferential side of the developing coupling 320 is provided with a clamped portion 321, which may be a clamping rib disposed around the circumferential side of the developing coupling 320. A clamping portion 151 matching the clamped portion 321 is provided on one side of the abutment member 150 in the B1 direction. The clamping portion 151 is a clamping groove structure, and the clamping groove structure has an arc-shaped contour matched with the circumferential side of the developing coupling 320. When the clamping groove is clamped with the clamping rib, the arc-shaped contour of the clamping portion 151 fits the circumferential side of the developing coupling 320, so that the engagement between the clamping portion 151 and the clamped portion 321 does not affect the rotation of the developing coupling 320. Through the abutment of the clamping portion 151 with the clamped portion 321, the abutment member 150 may drive the developing coupling 320 to move along the first direction.

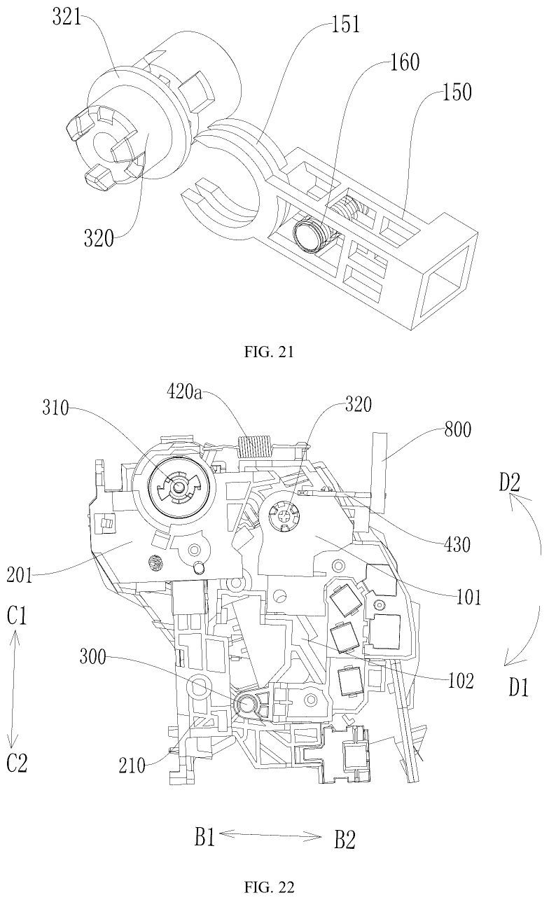

As shown in FIGS. 20 and 21, the abutment member 150 may abut against the separation control member 800 to receive the drive of the separation control member 800, so that the abutment member 150 may move along the A1 direction in the slot 1013. In some embodiment, one side of the abutment member 150 in the B2 direction is set as a plane structure, which abuts against the separation control member 800.

As shown in FIG. 21, the processing cartridge also includes a third type of elastic member 160, one end of the third type of elastic member 160 is connected to the developing frame 110, and the other end is connected to the abutment member 150. The third type of elastic member 160 may use a tension spring. Through the third type of elastic member 160, the abutment member 150 may rely on the elastic force to reset when it is out of abutment with the separation control member 800, so that the abutment member 150 may move (e.g., move along the A2 direction) and reset in the slot 1013, thereby realizing the function of the developing coupling 320 to extend and retract in the developing end cover 101.

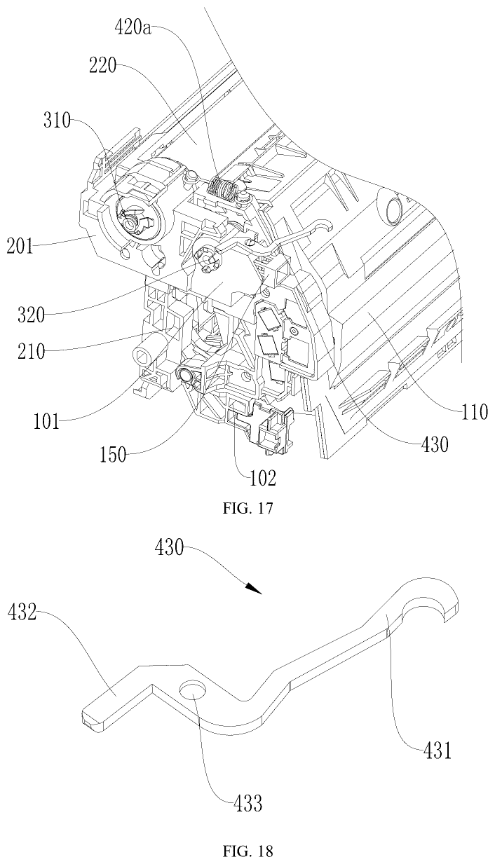

As shown in FIGS. 17 and 18, the separator 430 is movably disposed on the processing cartridge, and is used to receive the separation force of the electronic imaging device to drive the developing unit 100 to move along the separation direction D1. The separator 430 is a bent strip structure, and the outer shape of the separator 430 is roughly “Z” shaped. The separator 430 may be disposed on the side wall of the developing frame 110 at one end or both ends of the processing cartridge in the first direction. That is, the separator 430 is disposed on the side wall of the driving end and/or the non-driving end. Specifically, the separator 430 may be swingably disposed on the plane on the C1 direction of the developing end cover 101. In the third direction, the separator 430 is located on the upper side of the developing coupling 320 and the abutment member 150, and the separator 430 is located between the two ends of the processing cartridge in the third direction. That is, the separator 430 does not protrude from the processing cartridge in the third direction. During the installation of the processing cartridge, the separator 430 will not interfere with the electronic imaging device in the third direction. The separator 430 includes a hook part 431 and a front end 432. A rotating portion 433 is provided in the middle of the separator 430 and is located between the hook part 431 and the front end 432. The separator 430 is swingably disposed on the developing end cover 101 around the rotating portion 433.

Specifically, the rotating portion 433 is a socket. Inserted into the rotating portion 433 through a pin/pin shaft and connected to the developing end cover 101, the separator 430 swings around the position of the rotating portion 433. The swinging axis of the separator 430 extends along the third direction. That is, the separator 430 swings within the plane formed by the first direction and the second direction.

As shown in FIGS. 17, 18 and 20, the hook part 431 is a curved strip structure with a hook claw structure at its end. The hook part 431 is used to receive the separation force of the separation control member 800. Specifically, the separation control member 800 abuts against the hook claw of the hook part 431. The hook part 431 has a vector component extending along the first direction and a vector component extending along the second direction. Since the separator 430 may be disposed at the driving end and/or the non-driving end of the processing cartridge, the disclosed embodiment takes the separator 430 being disposed at the driving end as an example, and the hook part 431 has extension vector components along the A2 direction and the B2 direction.

It should be noted that the running trajectory of the separation control member 800 in the plane formed by the first direction and the second direction is an arc-shaped path, and has corresponding vector components in the first direction and the second direction. Correspondingly, the hook part 431 also has corresponding force components, so that the hook part 431 has a shape that conforms to the running trajectory of the separation control member 800, and may receive the separation force transmitted by the separation control member 800. The hook part 431 abuts against the separation control member 800, so that the separator 430 has a separation force moving along the second direction (i.e., B2 direction), driving the developing unit 100 to swing relative to the drum unit 200 along the separation direction D1, thereby separating the developing roller 120 from the photosensitive drum 220.

As shown in FIGS. 17, 18 and 20, the front end 432 is disposed opposite to the hook part 431 in the first direction of the separator 430. The front end 432 is also the end structure of the separator 430, and its end has a rounded structure. The separator 430 may swing between the initial position and the working position. In the initial position, the front end 432 is located at the front end of the processing cartridge (i.e., the end in the A1 direction). When the processing cartridge is being inserted into the electronic imaging device, since the processing cartridge is not fully mounted in place at this time, as the processing cartridge continues to move, the front end 432 first abuts against the side wall of the electronic imaging device and the separator 430 is pushed to swing with the installation action. The swinging of the separator 430 causes the hook part 431 to shift relative to the initial position to reach the position of engaging the separation control member 800 (i.e., the working position). In the second direction, the hook part 431 is farther away from the developing frame 110 in the working position than in the initial position, thereby facilitating the abutment with the separation control member 800. In the initial position, the hook part 431 is closer to the developing frame 110 and also prevents the hook part 431 from interfering with other components of the electronic imaging device during installation.

Furthermore, in order to enable the separator 430 to remain in the initial position before being fully mounted, the processing cartridge is also provided with a retaining member. Specifically, the retaining member may be a torsion spring (not shown), which is used to maintain the separator 430 in the initial position. In the initial position, the hook part 431 is close to the developing unit 100 (i.e., the hook part 431 is as close to the developing frame 110 as possible). When the front end 432 abuts against the side wall of the electronic imaging device, the torsion force of the torsion spring is overcome, so that the hook part 431 swings and is located in the working position. In the working position, the hook part 431 is away from the developing unit 100 (e.g., the hook part 431 reaches the position of the engagement with the separation control member 800). The above structure avoids the problem of too large an opening and closing angle between the hook part 431 and the developing frame 110 in the B2 direction, which causes interference when the processing cartridge is mounted.

When the processing cartridge starts to develop, the separation control member 800 of the electronic imaging device moves simultaneously in the direction close to the B1 end and the A1 end of the processing cartridge, abuts against the abutment member 150 and drives the abutment member 150 to move in the A1 direction, so that the developing coupling 320 engaged with the abutment member 150 extends in the A1 direction to engage with the developing drive head and receive the driving force of the electronic imaging device. The third type of elastic member 160 is deformed (e.g., the tension spring is stretched) when the abutment member 150 moves.

As shown in FIG. 22, when the developing work stops, the separation control member 800 of the electronic imaging device moves in the direction away from the B1 side and the A1 side of the processing cartridge, and the separation control member 800 abuts against the hook part 431 of the separator 430 and receives the separation force, so that the developing unit 100 swings from the first position to the second position along the separation direction D1. The developing roller 120 and the photosensitive drum 220 are separated. At the same time, the abutment member 150 is no longer affected by the abutment of the separation control member 800. Under the action of the third type of elastic member 160, the abutment member 150 and the developing coupling 320 move along the A2 direction to the retracted position.

In the disclosed embodiment, a second type of elastic member 420a (i.e., a control structure) is provided on the processing cartridge to offset the self-gravity of the developing unit 100, so that the developing unit 100 is maintained in the first position, and the developing roller 120 is in contact with the photosensitive drum 220. The processing cartridge is also provided with a separator 430, which may receive the separation force output by the separation control member 800 of the electronic imaging device to achieve the drum-roller separation. The separator 430 is provided on the side wall of the processing cartridge, and extends outward along the second direction relative to the developing frame 110. The position of the separator 430 may better adapt to the installation direction of the processing cartridge, and may ensure that the upper and lower sides of the processing cartridge will not interfere with the installation, and will not interfere with or damage the separator 430.

The other structures of the processing cartridge of Embodiment 3 are identical to those of Embodiment 1 and will not be described again.

### Embodiment 4

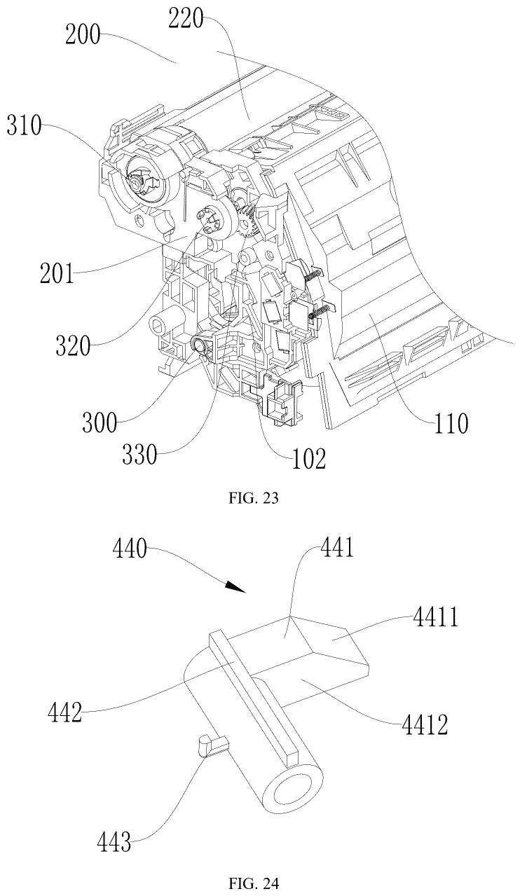

As shown in FIG. 23, Embodiment 4 provides another processing cartridge. Compared with Embodiment 3, the difference lies in that the abutment member is omitted and a driving gear is provided. The structure of the separator is different.

As shown in FIG. 23, the processing cartridge structure of the disclosed embodiment is different from that of the processing cartridge structure of Embodiment 1 in that, since the driving structure of the developing unit 100 is complex and difficult to engage, and the collision between the structures will also cause the wear of the developing coupling 320 structure, the developing coupling 320 of this scheme is rotatably disposed on the photosensitive end cover 201 and supported by the photosensitive end cover 201. The developing coupling 320 may not be extended or retracted, nor does it move with the drum-roller contact/separation process of the developing unit 100. The developing coupling 320 is also not connected to the shaft of the powder feeding roller 130. That is, the developing coupling 320 may not directly drive the powder feeding roller 130 to rotate when rotating. When the drum and roller of the processing cartridge is separated, the developing coupling 320 is engaged with the developing drive head of the electronic imaging device. A driving gear 330 is provided on the A1 direction of the developing frame 110. The driving gear 330 is coaxially disposed at the end of a driving shaft (not shown). The driving shaft is passed through the developing frame 110 along the first direction. A corresponding gear is coaxially disposed at the end of the driving shaft in the A2 direction, which is meshed with the developing roller gear 340, the powder feeding roller gear 350, and the stirring gear to transmit the driving force. That is, the developing roller 120, the powder feeding roller 130 and the stirring frame 140 are driven through the non-driving end. The driving gear 330 is supported on the developing frame 110. When the developing unit 100 moves to the second position (i.e., drum and roller in separation), the driving gear 330 also moves along the separation direction D1. The driving gear 330 disengages from the developing coupling 320 and stops receiving the driving force of the developing coupling 320. The developing coupling 320 is engaged with the developing drive head and rotates. That is, when the drum and roller are separated, the developing coupling 320 is in an idling state. When the developing unit 100 moves to the first position along the contact direction D2 (i.e., drum and roller in contact), the driving gear 330 engages with the developing coupling 320, and the driving force may be transmitted to the non-driving end.

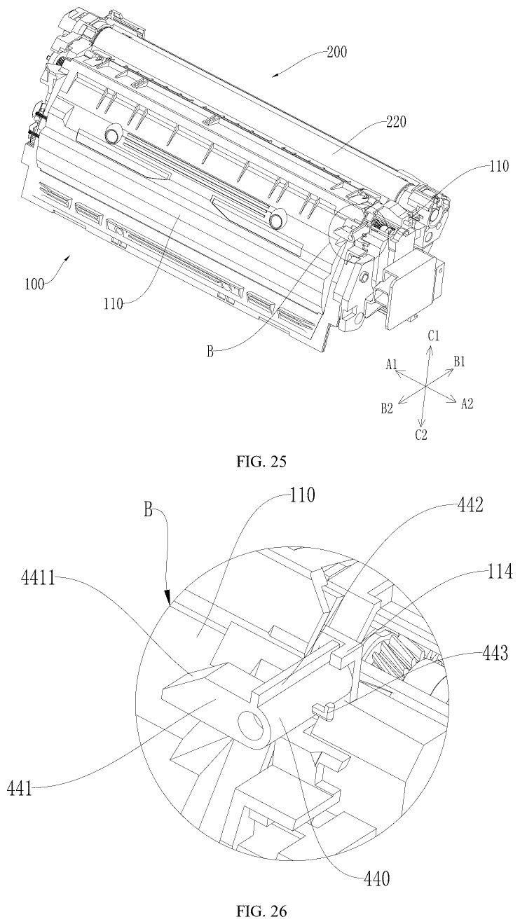

As shown in FIGS. 24 and 25, the separator 440 of the disclosed embodiment is set at the non-driving end as an example. The separator 440 may be swung and reset on the developing frame 110. Apparently, the separator 440 may also be set on the developing end cover 101. As shown in the illustrated embodiment, in the third direction, the separator 440 is located between the two ends of the processing cartridge in the third direction. That is, the separator 440 does not protrude from the processing cartridge in the third direction and does not interfere with the two ends of the processing cartridge in the third direction.

The outer shape of the separator 440 is an “L” shaped structure. The separator 440 includes an abutment part 441 and a positioning part 442. In order to better adapt to the swinging shape of the separator 440, the shape of the separator 440 extending in the second direction (i.e., B2 direction) is a cylindrical structure. A connecting through hole is provided inside the cylindrical structure. The separator 440 is sleeved on a connecting column on the developing frame 110 through the connecting through hole and may swing around the connecting column. The extension direction of the connecting column is along the B2 direction. That is, the swinging axis of the separator 440 is along the second direction. The abutment part 441 is provided at the end of the separator along the B2 direction. The abutment part 441 extends along the first direction. An abutment slope 4411 is provided at the end of the abutment part 441 (i.e., the end away from the cylindrical structure). The abutment slope 4411 is closer to the end of the separation control member 800, which is convenient for abutting with the separation control member 800. An abutment plane 4412 is provided on the B1 direction of the abutment part 441, which is used to abut with the separation control member 800 to receive the separation force, so that the developing frame 110 is forced to swing.

As shown in FIG. 26, the positioning part 442 is a part protruding from the cylindrical structure of the separator 440, which may be set to a convex strip structure. The positioning part 442 is located on the upper side (i.e., C1 direction) of the separator 440, and the developing frame 110 is provided with a limiting part 114. The limiting part 114 is a structure protruding along the second direction (i.e., B2 direction) on the developing frame 110. The limiting part 114 may abut against the positioning part 442 in the first direction. It should be noted that the initial position of the separator 440 is a state where the positioning part 442 abuts against the limiting part 114. The initial position of the separator 440 is identical to the working position, both of which are the position where the positioning part 442 abuts against the limiting part 114, so that the separator 440 may maintain a specific swinging position to facilitate the abutment part 441 to abut against the separation control member 800. Therefore, in order to prevent the separator 440 from excessive rotation, a required position is obtained based on the limitation provided by the positioning part 442 and the limiting part 114. In order to enable the separator 440 to be reset to the initial position, in the disclosed embodiment, a tension spring (not shown) is provided to connect the separator 440 and the developing frame 110 so that the separator 440 has a restoring elastic force. A hook 443 is provided on the separator 440 to facilitate the connection with the tension spring, one end of the tension spring is connected to the hook 443, and the other end is connected to the developing frame 110 (or any fixed structure).

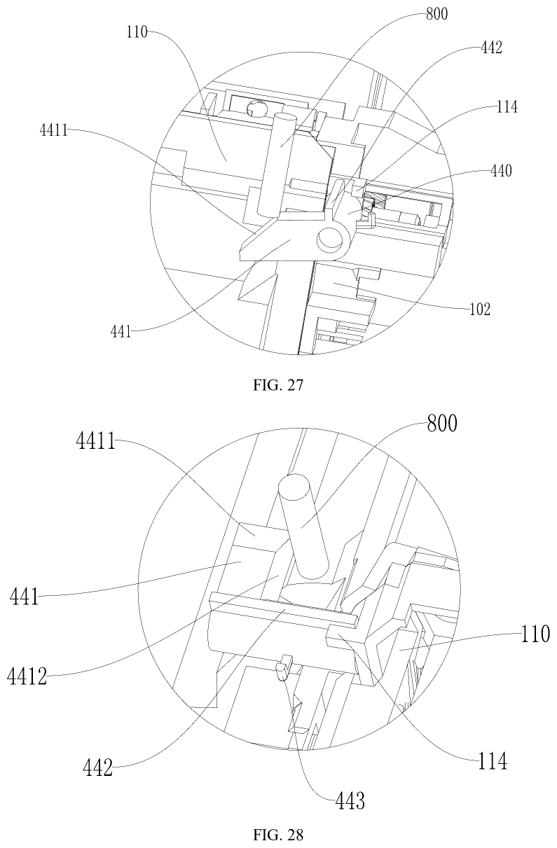

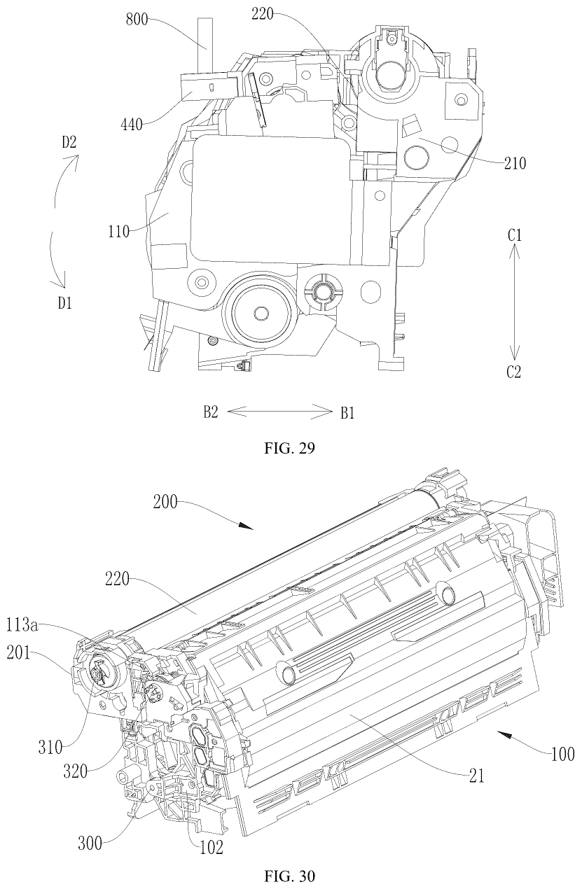

In the initial state, the processing cartridge is maintained in contact with the photosensitive drum 220 and the developing roller 120 by the second type of elastic member 420a (i.e., in the first position), and the separator 440 is also in the initial position. When the processing cartridge is mounted in place in the electronic imaging device, as shown in FIG. 27, the separation control member 800 moves in a direction close to the processing cartridge and abuts against the abutment slope 4411, overcoming the elastic force of the tension spring connected to the separator 440, so that the separator 440 rotates and avoids the separation control member 800 by rotating against the abutment slope 4411, as shown in FIG. 28. The separation control member 800 then disengages the abutment slope 4411 in the B1 direction of the abutment part 441. That is, the separation control member 800 reaches the separation preparation position, and the separator 440 is restored to the initial position (also the working position, capable of receiving the separation force of the separation control member 800) under the action of the tension spring. As shown in FIG. 29, when the processing cartridge stops developing, the separation control member 800 abuts against the abutment plane 4412 of the separator 440 and applies a separation force to the separator 440, so that the separator 440 drives the developing frame 110 to swing to the second position along the separation direction D1, and the developing roller 120 is separated from the photosensitive drum 220.

The other structures of the processing cartridge of Embodiment 4 are identical to those of Embodiment 1 and will not be described again.

### Embodiment 5

Embodiment 5 provides a processing cartridge, which is different from Embodiment 1 in that the control structure is different.

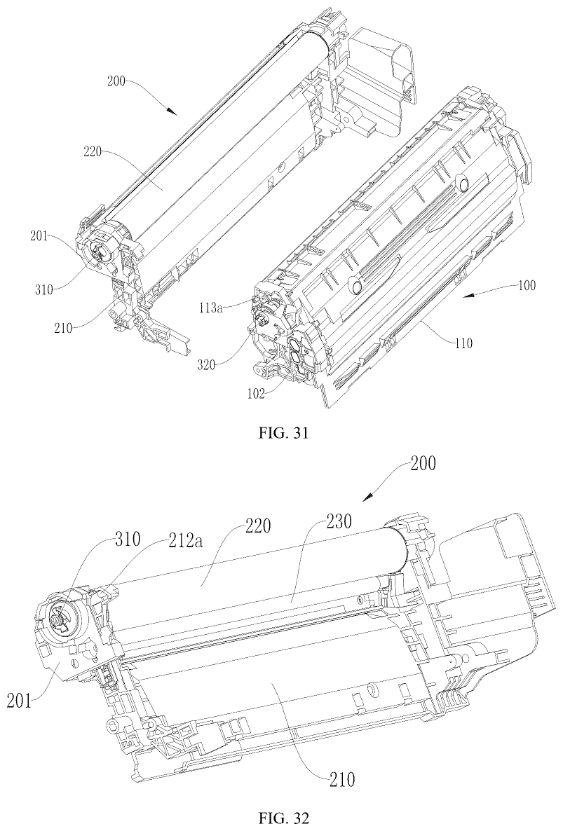

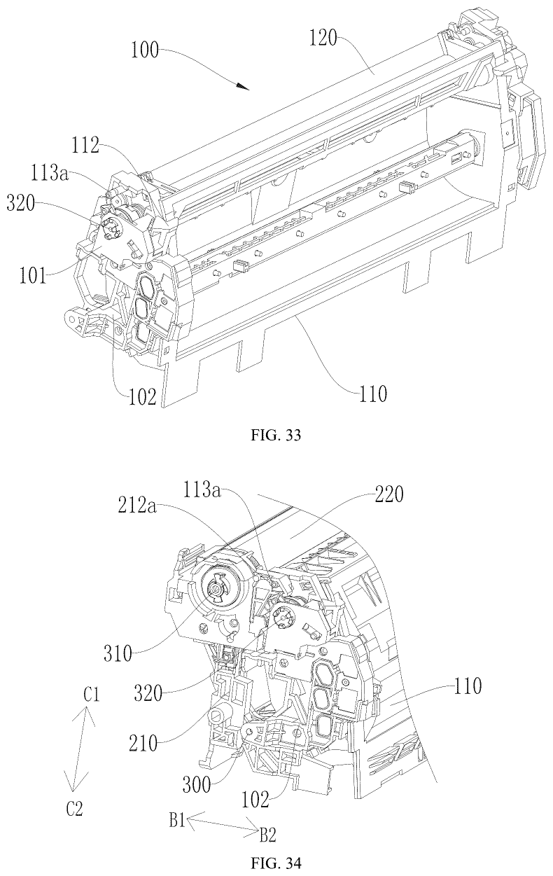

As shown in FIGS. 30 to 35, the control structure is disposed on the processing cartridge. In the disclosed embodiment, the control structure is closer to the C1 direction (i.e., upper side) of the processing cartridge. The control structure includes a limiting part and a limited part. The limiting part and the limited part may abut against each other to overcome the effect of the self-gravity of the developing unit 100, thereby limiting the movement of the developing unit along the separation direction D1, so that the developing roller 120 and the photosensitive drum 220 remain in contact. In the disclosed embodiment, the control structure may be disposed at the driving end or the non-driving end. Taking the driving end as an example, the limiting part is disposed on the photosensitive frame 210, and the limited part is disposed on the developing frame 110. The limited part abuts against the limiting part to limit the swinging range of the developing unit 100 relative to the drum unit 200, thereby limiting the separation of the developing roller 120 and the photosensitive drum 220.

As shown in FIGS. 32, 33 and 36, the limiting part is constructed as a limiting hole 212a, which is recessed along the first direction or passes through one end (e.g., the end in the A1 direction) of the photosensitive frame 210. In some embodiments, the limiting hole 212a is disposed on the photosensitive end cover 201 and is located on the B2 direction of the photosensitive end cover 201. In some embodiments, the shape of the limiting hole 212a is a strip-shaped hole, and its length direction extends in the second direction for the movement of the limited part. The limited part is constructed as a limiting column 113a, which is a cylindrical structure. The limiting column 113a may be disposed on the developing bearing 102 and is located on the B1 direction of the developing bearing 102.

The limiting column 113a is protruding along the A1 direction on the developing bearing 102. The limiting column 113a may be inserted into the limiting hole 212a, and may move along the inner wall of the limiting hole 212a in the second direction, and abut against the end of the limiting hole 212a in the second direction. In some embodiments, the structures of the limiting part and the limited part may be interchangeable to achieve the same effect, and may be designed according to different actual conditions.

In the disclosed embodiment, the developing bearing 102 is also provided with a force-bearing part 112 for receiving the thrust of the electronic imaging device. The electronic imaging device has a force-applying member (not shown) for outputting the thrust. The force-applying member is a swing stem structure. The force-bearing part 112 abuts against the force-applying member to cause the developing frame 110 to swing.

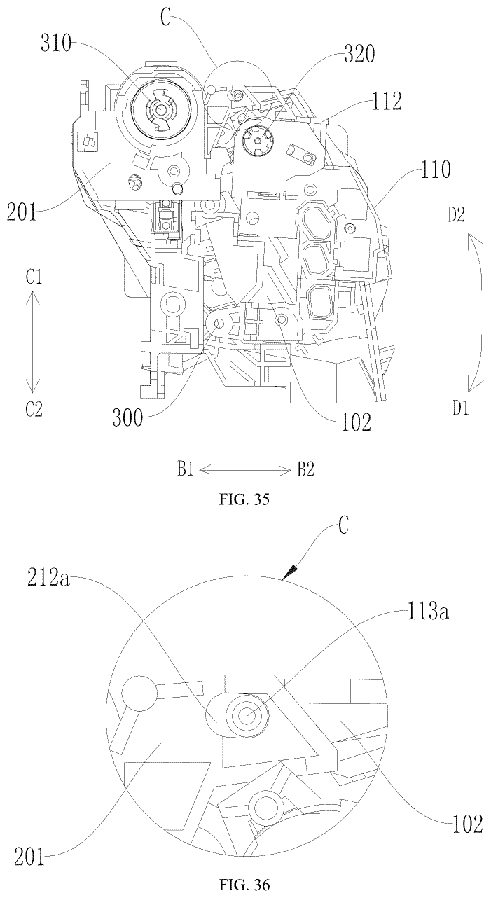

When in use, the force-bearing part 112 abuts against the force-applying member to receive the contact force, so that the developing unit 100 swings a small distance along the separation-contact direction D2 (i.e., counterclockwise in FIG. 35), and the limiting column 113a also moves along the limiting hole 212a toward the B1 direction. At this time, the developing roller 120 and the photosensitive drum 220 are in close contact to perform the developing operation. Since the swinging center of the developing unit 100 is closer to the C2 direction of the processing cartridge, when the force-bearing part 112 is out of contact with the force-applying member (i.e., the force-bearing part 112 does not receive the contact force of the force-applying member of the electronic imaging device), the developing unit 100 swings a small distance around the swinging center (i.e., the center of the connecting part 300 in FIG. 35) along the separation direction D1 (i.e., clockwise in FIG. 35) due to its self-gravity, so that the limiting column 113a moves along the limiting hole 212a toward the B2 direction. Finally, the limiting column 113a and the end of the limiting hole 212a in the B2 direction (i.e., away from the contact force of the force-applying member of the electronic imaging device) are aligned. Therefore, the small distance that the limiting column 113a moves in the limiting hole 212a reduces the impact between the developing roller 120 and the photosensitive drum 220, but also limits the swinging range of the developing unit 100 under the action of its self-gravity, thereby avoiding collision and wear caused by excessive separation and swinging distance of the developing frame 110.

When the processing cartridge is developing, the force-bearing part 112 abuts against the force-applying member, so that the developing roller 120 is in close contact with the photosensitive drum 220, and the developing work may be better realized. In the non-working state (e.g., after the development is completed), the force-bearing part 112 of the developing frame 110 does not receive the contact force. Under the limitation of the control structure, the developing frame 110 may swing slightly due to its self-gravity, so that the developing roller 120 contacts but does not close to the photosensitive drum 220, so as to reduce the wear between the developing roller 120 and the photosensitive drum 220. By limiting the position of the developing frame 110 in the non-working state through the control structure, the wear problem caused by the collision between the developing frame 110 and the photosensitive frame 210 due to the large drop caused by the self-gravity of the developing unit is avoided, and the service life of the processing cartridge is extended.

The other structures of the processing cartridge of Embodiment 5 are identical to those of Embodiment 1 and will not be described again.

### Embodiment 6

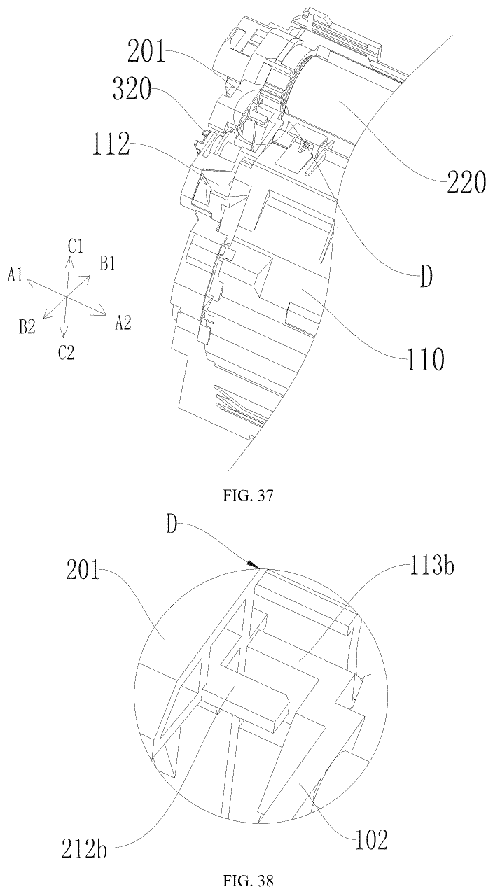

As shown in FIG. 37, the structure of Embodiment 6 is mostly identical to that of Embodiment 5, except that the specific structure of the control structure is different. The disclosed embodiment does not use a jack-limiting structure, but a rib-abutment limiting structure.

Specifically, as shown in FIGS. 37 and 38, the control structure includes a limiting part and a limited part, the limiting part is constructed as a first rib 212b protruding along the A2 direction on the photosensitive frame 210, and the limited part is constructed as a second rib 113b protruding along the A1 direction on the developing bearing 102. The first rib 212b and the second rib 113b may abut against each other. In the second direction, the projections of the first rib 212b and the second rib 113b overlap, and the first rib 212b is located on the B2 direction of the second rib 113b, so that when the developing unit 100 swings along the separation direction D1, the developing unit 100 is limited by the abutment between the first rib 212b and the second rib 113b, so as to limit the movement of the developing unit 100 along the separation direction D1 under the action of its self-gravity. In the disclosed embodiment, the width of the first rib 212b in the third direction is smaller than the width of the second rib 113b in the third direction. When the developing unit 100 swings, the second rib 113b has a tendency to move toward the third direction. This arrangement may prevent the first rib 212b and the second rib 113b from being offset when they abut against each other, thereby failing to limit the developing frame 110. In the disclosed embodiment, the shapes of the first rib 212b and the second rib 113b are not limited, as long as they may abut against each other.

In the working state of the processing cartridge (i.e., when performing the developing work), the force-bearing part 112 abuts against the force-applying member to receive the contact force, so that the developing unit 100 swings along the contact direction D2, and the developing roller 120 abuts tightly against the photosensitive drum 220 to perform the developing work. At this time, there is a gap between the first rib 212b and the second rib 113b in the second direction. In the non-working state, the force-bearing part 112 is disengaged from the abutment with the force-applying member, and the developing unit 100 moves along the separation direction D1 due to gravity, specifically, moves a small distance along the B2 direction and the C2 direction. The first rib 212b abuts against the second rib 113b, so that the developing unit 100 is limited. At this time, the developing roller 120 and the photosensitive drum 220 are still in contact, but not in a tight abutment state. Compared with the developing work, the impact between the developing roller 120 and the photosensitive drum 220 is reduced.

The other structures of the processing cartridge of Embodiment 6 are identical to those of Embodiment 1 and will not be described again.

### Embodiment 7

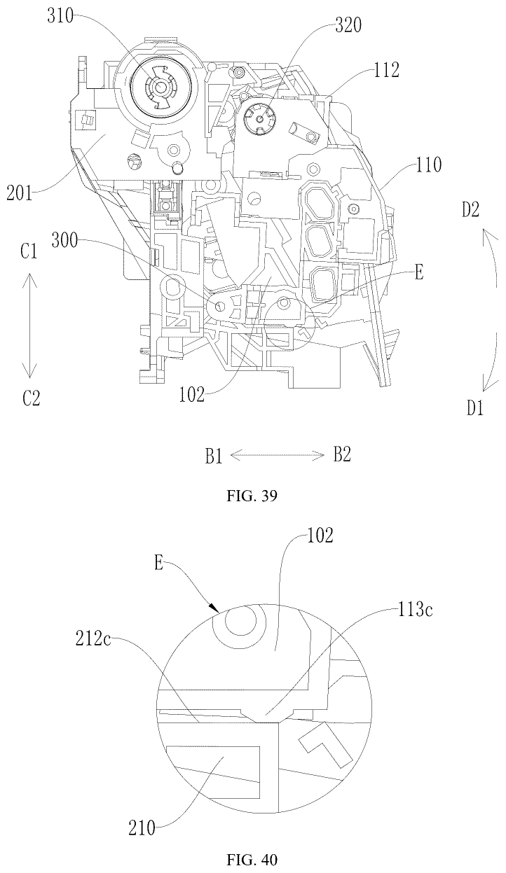

As shown in FIG. 39, most of the structures of Embodiment 7 are identical to those of Embodiment 5, except that the position and structure of the control structure are different. In the disclosed embodiment, the control structure is located closer to the swinging center of the processing cartridge (i.e., the center of the connecting part 300), and the control structure is located on the B2 direction and the C2 direction of the swinging center. Similarly, the swinging range of the developing unit 100 along the separation direction D1 is limited by abutment, so that the developing roller 120 maintains contact with the photosensitive drum 220.

Specifically, as shown in FIGS. 39 and 40, the control structure includes a limiting part and a limited part. The limiting part and the limited part may abut against each other to limit the swinging of the developing frame 110. The limiting part or the limited part protrudes along the third direction. In the disclosed embodiment, the limiting part is constructed as an abutment surface 212c. The abutment surface 212c is a plane on the photosensitive frame 210, and the abutment surface 212c is intersecting or perpendicular to the third direction. The limited part is constructed as a limiting protrusion 113c, and the limiting protrusion 113c is a structure protruding along the C2 direction on the side face of the developing bearing 102, and the end thereof abutting against the abutment surface 212c may be set to a plane or an arc shape, and the limiting protrusion 113c is located on the upper side of the abutment surface 212c. The limiting protrusion 113c is in contact with the abutment surface 212c to limit the swinging range of the developing unit 100 along the separation direction D1 (i.e., clockwise direction in FIG. 39), thereby maintaining the contact between the developing roller 120 and the photosensitive drum 220. In some embodiments, the limiting part may protrude along the C1 direction. That is, the limited part is constructed as a planar structure, and the limiting part is in contact with the limited part, which may also achieve the above described effect.

In the working state of the processing cartridge, the force-bearing part 112 abuts against the force-applying member so that the developing frame 110 receives the contact force, and the developing unit 100 swings around the swinging center (i.e., the center of the connecting part 300) along the contact direction D2. Specifically, the developing unit moves a small distance along the C1 direction and the B1 direction, and the limiting protrusion 113c also moves a small distance along the C1 direction, so that the developing roller 120 and the photosensitive drum 220 are closely abutted to perform the developing work. In the non-working state, when the force-bearing part 112 is out of contact with the force-applying member, the developing unit 100 swings around the swinging center along the separation direction D1 due to the self-gravity. That is, the developing unit 100 has a small movement component along the C2 direction and the B2 direction, and finally the limiting protrusion 113c abuts against the abutment surface 212c (i.e., the developing unit 100 may no longer move), at which point the developing roller 120 and the photosensitive drum 220 are still in contact, but not in a close abutting state, and the impact between the developing roller 120 and the photosensitive drum 220 is reduced compared with the moment of developing work.

The other structures of the processing cartridge of Embodiment 7 are identical to those of Embodiment 1 and will not be described again.

### Embodiment 8

The structures of Embodiment 8 are mostly identical to those of Embodiment 7, except that, on the basis of Embodiment 7, the disclosed embodiment adds limiting points of the control structure, so that the developing roller 120 and the photosensitive drum 220 are kept in a state of close contact.

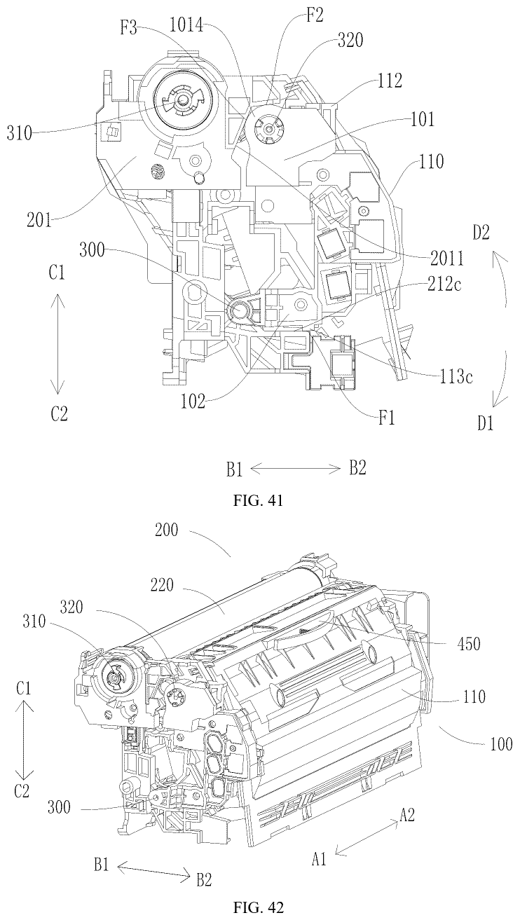

Specifically, as shown in FIG. 41, the control structure of the disclosed embodiment has three limiting points, with the limiting protrusion 113c abutting against the abutment surface 212c as the first limiting point F1. The first limiting point F1 is closer to the C2 direction of the processing cartridge, and the other two limiting points are closer to the C1 direction of the processing cartridge, and are farther away from the swinging center than the first limiting point F1. The B1 direction of the developing end cover 101 has an arc portion 1014. The B2 direction of the photosensitive end cover 201 is provided with a limiting opening 2011, the limiting opening 2011 is an opening structure, and the opening faces the arc portion 1014 (i.e., faces the B2 direction). The limiting opening 2011 has two connected inner walls, the angle between the two inner walls is an obtuse angle, and the arc outer surface of the arc portion 1014 may abut/be tangent to the two inner walls of the limiting opening 2011, thereby forming a second limiting point F2 and a third limiting point F3, so as to limit the movement of the developing end cover 101 in the C1 direction and the B2 direction. It may be understood that the abutment between the limiting protrusion 113c and the abutment surface 212c may limit the movement of the developing frame 110 along the C2 direction, and the abutment between the arc portion 1014 and the limiting opening 2011 may limit the movement of the developing frame 110 along the C1 direction and the B2 direction. The simultaneous action of the two makes it impossible for the developing unit 100 to move relative to the drum unit 200 (i.e., the effect of the self-gravity of the developing unit 100 is completely offset), and the developing roller 120 keeps maintaining close contact with the photosensitive drum 220.

It should be noted that the working principle of the disclosed embodiment is different from that of the above described embodiments. When the force-bearing part 112 abuts against the force-applying member to receive the thrust, the developing frame 110 may not move slightly. Similarly, when the thrust is withdrawn, the developing frame 110 may not move slightly due to its self-gravity. That is, no matter whether the processing cartridge is in the developing working state or the non-working state, under the action of the limiting protrusion 113c and the abutment surface 212c, the arc portion 1014 and the limiting opening 2011, the developing roller 120 and the photosensitive drum 220 keep maintaining the same degree of close abutment. Therefore, the drum and roller are not separated, which may effectively solve the wear problem caused by the collision between the developing frame 110 and the photosensitive frame 210 due to the swinging of its self-gravity of the developing frame 110.

The other structures of the processing cartridge of Embodiment 8 are identical to those of Embodiment 1 and will not be described again.

### Embodiment 9

Embodiment 9 provides a processing cartridge, which is different from Embodiment 1 in that the control structure is different.

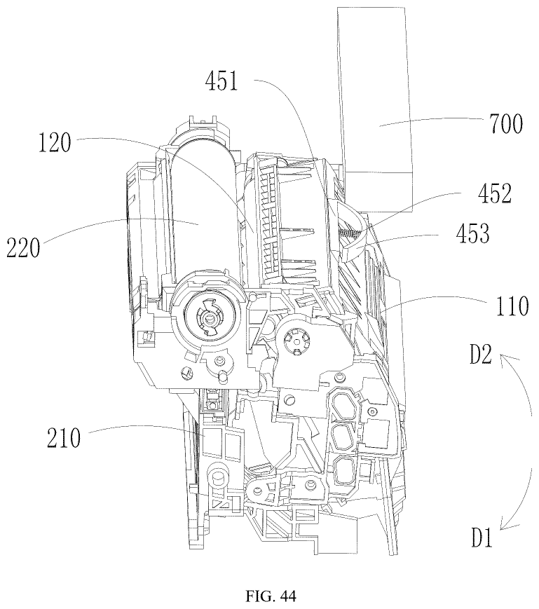

As shown in FIGS. 42 to 46, in the disclosed embodiment, the control structure of the processing cartridge includes a pressing member 450, which is configured to cooperate with the electronic imaging device to provide a force to move the developing unit 100 from the second position to the first position, thereby offsetting the self-gravity of the developing unit 100, so that the developing unit 100 may not move along the separation direction D1 after the processing cartridge is mounted in the electronic imaging device. The pressing member 450 is protrudingly disposed on the developing frame 110 along the B2 direction, and the pressing member 450 is disposed at the upper end of the processing cartridge in the third direction, that is, close to the developing roller 120. The pressing member 450 includes a mounting portion 451, a buffer portion 452 and a pressing portion 453. The mounting portion 451 of the pressing member 450 is mounted on the developing frame 110. Specifically, in the disclosed embodiment, the pressing member 450 has a length direction, and the pressing member 450 is mounted on the developing frame 110 in a direction consistent with the length direction of the processing cartridge (i.e., the first direction). The mounting portion 451 is a strip-shaped structure, which may be mounted on the B2 direction of the developing frame 110 by pasting, welding, or snapping. The pressing portion 453 is an arc-shaped structure, one end or both ends of the pressing portion 453 are connected to the mounting portion 451. The buffer portion 452 is disposed between the mounting portion 451 and the pressing portion 453 (specifically, the buffer portion 452 may be abutted at the middle position of the two in the length direction), so that a buffer region is generated between the mounting portion 451 and the pressing portion 453 to adjust the impact between the developing roller 120 and the photosensitive drum 220, thereby improving the developing quality. Specifically, in the disclosed embodiment, the buffer portion 452 may be composed of a spring, and the elastic expansion direction of the spring extends along the second direction. One end of the spring abuts the mounting portion 451, and the other end abuts the pressing portion 453. At the same time, the buffer portion 452 may also be composed of other elastic parts that may play the same effect, such as elastic rubber, elastic sponge, etc., and the elastic part may be set to one or more. The pressing portion 453 is configured to abut against the cross beam structure 700 of the electronic imaging device, so as to be pressed by the cross beam structure 700. The pressing force of the cross beam structure 700 acts on the developing unit 100 through the pressing member, so that the developing unit 100 rotates and moves from the second position to the first position along the contact direction D2, and the developing roller 120 is closely abutted against the photosensitive drum 220. In the disclosed embodiment, the mounting portion of the pressing member 450 is integrally formed with the pressing portion 453. Alternatively, the pressing portion and the mounting portion may also be separately provided.

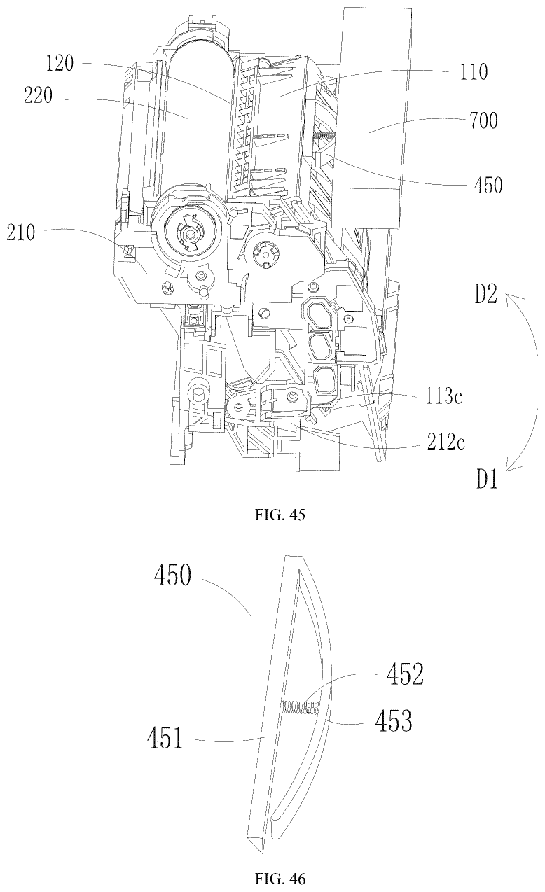

As shown in FIG. 45, when the pressing member 450 is pressed and stressed by the cross beam structure 700 of the electronic imaging device, the force of the pressing member 450 on the developing unit 100 causes the developing unit 100 to rotate along the contact direction D2 around the axis (i.e., the rotation axis) of the connecting part 300. That is, the force of the pressing member 450 on the developing unit 100 is in the counterclockwise direction, and the developing unit 100 rotates from the second position to the first position along the contact direction D2. Therefore, after the processing cartridge is placed in the electronic imaging device, the photosensitive drum 220 and the developing roller 120 maintain a close contact state to ensure printing quality.

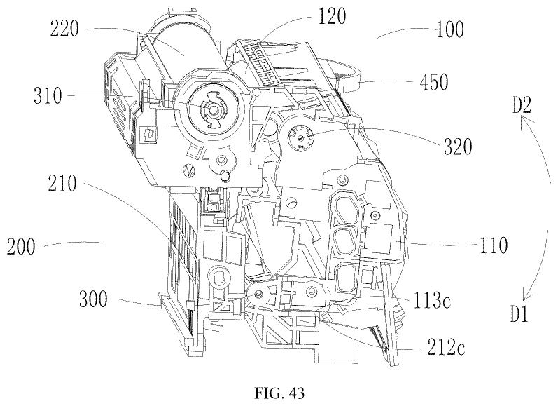

Further, as shown in FIGS. 43 and 45, the control structure also includes a control structure as in Embodiment 7, including a limiting part and a limited part. The limiting part is the abutment surface 212c on the photosensitive frame 210, and the limited part is the limiting protrusion 113c on the developing frame 110, and the limiting part cooperates with the limited part to limit the position of the developing unit 100 in the separation direction D1, so that the movement of the developing unit 100 along the separation direction D1 is limited under the action of its self-gravity. The developing unit 100 may not continue to move in the separation direction D1, thereby ensuring the stability of the processing cartridge before the processing cartridge is placed in the electronic imaging device, and not generating an excessive separation distance.

The processing cartridge of the disclosed embodiment is provided with a pressing member 450 on the developing frame 110, so that when the processing cartridge is placed in the electronic imaging device, the photosensitive drum 220 and the developing roller 120 keep in contact, which solves the problem of relying on the gravity of the developing frame 110 itself to separate in the existing technologies. The processing cartridge developing frame 110 includes a powder bin structure, and the powder bin usually contains a large amount of carbon powder. Therefore, the developing frame part has a large mass, which causes a rigid collision between the structures when separating by the gravity of the developing frame part, which will cause wear and even damage to the parts of the processing cartridge in the long run.

The other structures of the processing cartridge of Embodiment 9 are identical to those of Embodiment 1 and will not be described again.

### Embodiment 10

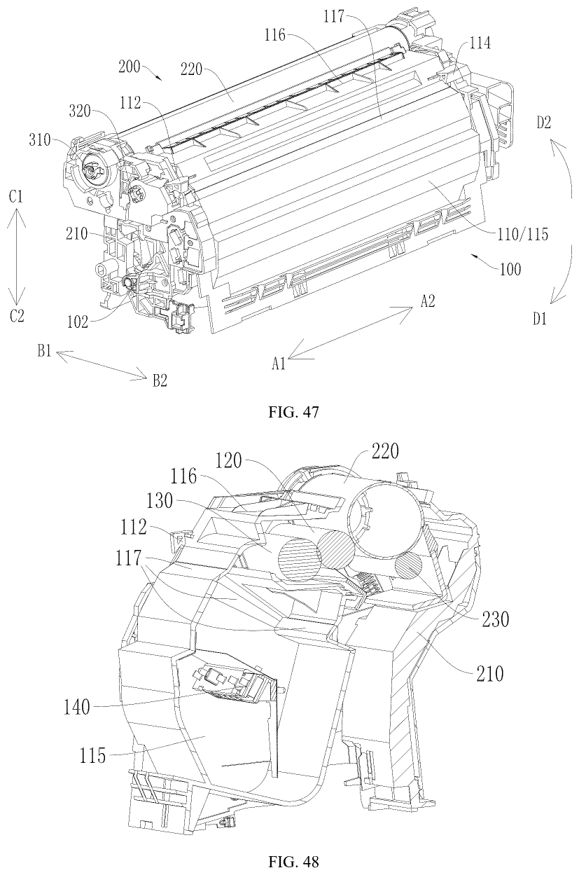

As shown in FIGS. 47 to 49, in Embodiment 10, the control structure includes a rotatable part 116, which drives the developing roller 120 away from or close to the photosensitive drum 220. The rotatable part 116 is connected to the powder bin 115. The length direction of the powder bin 115 and the rotatable part 116 extends along the first direction. In the third direction, the rotatable part 116 is located on the upper side of the powder bin 115 (i.e., the side of the C1 direction). The powder bin 115 stores developer (e.g., carbon powder). The powder bin 115 is provided with a stirring frame 140. The carbon powder in the powder bin 115 is stirred by the stirring frame 140 to prevent the carbon powder from agglomerating. At the same time, the carbon powder may also be transported toward the rotatable part 116. A developing roller 120 and a powder feeding roller 130 are disposed in the rotatable part 116, and the powder bin 115 is connected to the inside of the rotatable part 116. The powder bin 115 and the rotatable part 116 are connected by a flexible member 117. The flexible member 117 may be deformed. The flexible member 117 may be specifically a flexible soft glue. The powder bin 115 and the rotatable part 116 are connected by the flexible soft glue so that the rotatable part 116 may move relative to the powder bin 115, thereby driving the developing roller 120 to move together to achieve contact or separation between the developing roller 120 and the photosensitive drum 220. The flexible soft glue covers the connection port between the powder bin 115 and the rotatable part 116 along the circumferential direction, thereby forming a sealing structure to prevent leakage of the developer.

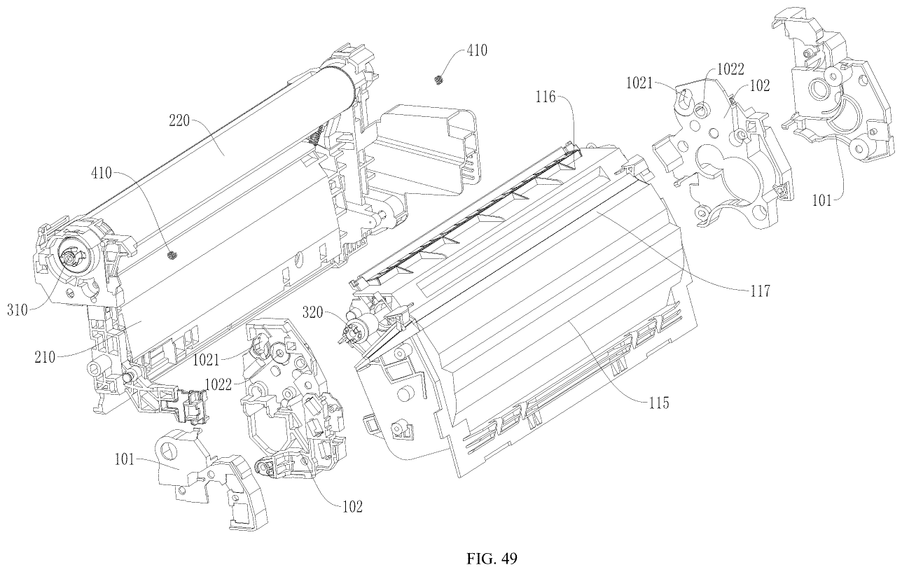

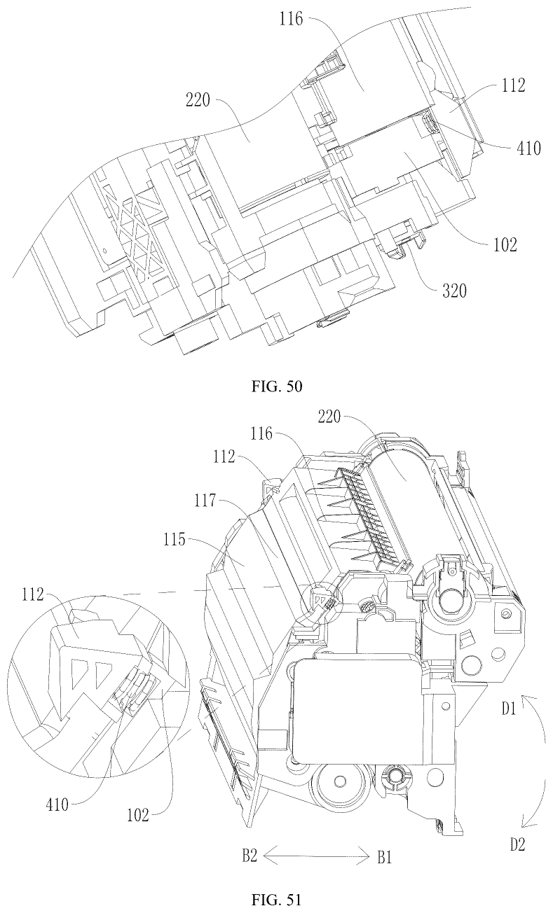

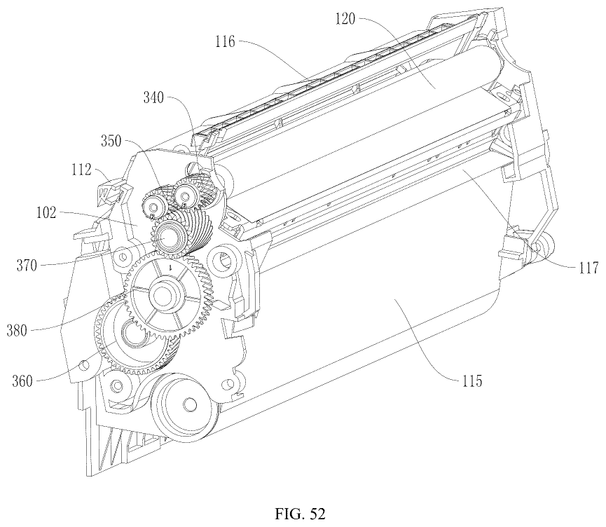

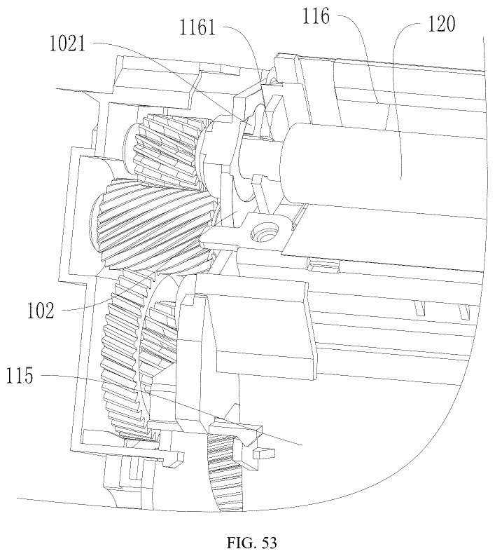

Further, as shown in FIGS. 49 to 52, the powder bin 115 and the rotatable part 116 are both supported by the developing bearing 102. The two ends of the powder bin 115 are fixedly supported on the developing bearing 102. That is, the powder bin 115 and the developing bearing 102 are in a stationary state. The two ends of the rotatable part 116 are movably supported on the developing bearing 102. Specifically, the developing bearing 102 is provided with a supporting hole 1021 for supporting the developing roller 120. The shaft of the developing roller 120 extends out of the end wall of the rotatable part 116 and is inserted into the supporting hole 1021 and supported by the supporting hole 1021. In some embodiments, the supporting hole 1021 is an arc-shaped hole. The developing roller 120 may move relative to the developing bearing 102 within the range of the supporting hole 1021. As shown in FIG. 53, the two ends of the rotatable part 116 are also provided with a clamping groove 1161, which is clamped on the two ends of the shaft of the developing roller 120, so that the rotatable part 116 may drive the developing roller 120 to move.

As shown in FIG. 49, the powder feeding roller 130 is disposed in the rotatable part 116, and its surface contacts the surface of the developing roller 120, thereby conveying the carbon powder to the developing roller 120 and being adsorbed by the charged developing roller 120. The shaft of the powder feeding roller 130 also extends out of the end wall of the rotatable part 116 and is inserted into the shaft hole 1022 (e.g., a circular hole) of the developing bearing 102 and supported by the developing bearing 102. The axis of the powder feeding roller 130 is the rotation center of the rotatable part 116. That is, when the rotatable part 116 moves relative to the powder bin 115/developing bearing 102, the position of the powder feeding roller 130 is unchanged, and the rotatable part 116 may move around the rotation center (i.e., the axis of the powder feeding roller 130) between the first position where the developing roller 120 contacts the photosensitive drum 220 and the second position where the developing roller 120 separates from the photosensitive drum 220.

Furthermore, as shown in FIGS. 47, 50 and 51, the rotatable part 116 is also provided with a force-bearing part 112, and the force-bearing part 112 is configured to receive the contact force applied by the force-applying member of the electronic imaging device to move the rotatable part 116 from the second position to the first position. The force-bearing part 112 may be a protruding structure disposed on the rotatable part 116, and the force-bearing part 112 is disposed near the upper end of the rotatable part 116 in the third direction (i.e., the end in the C1 direction). The force-bearing part 112 is disposed on the side of the rotatable part 116 in the B2 direction in the second direction. The force-bearing part 112 may be disposed at one end or both ends of the rotatable part 116 in the first direction.

Furthermore, as shown in FIGS. 49 to 51, the processing cartridge also includes a separator, which is a first type of elastic member 410. The first type of elastic member 410 is disposed between the developing bearing 102 and the rotatable part 116, and the first type of elastic member 410 is constructed to provide a separation force that moves the rotatable part 116 from the first position to the second position. In some embodiments, one end of the first type of elastic member 410 abuts against the developing bearing 102, and the other end abuts against the side of the force-bearing part 112 facing the B1 direction. The elastic expansion direction of the first type of elastic member 410 is along the second direction, and the direction of the separation force applied by the first type of elastic member 410 to the rotatable part 116 is along the B2 direction. When the processing cartridge is not subjected to other external forces (e.g., the state before being mounted in the electronic imaging device, the electronic imaging device is not in operation), the rotatable part 116 is in the second position under the action of the first type of elastic member 410, and the developing roller 120 is not in contact with the photosensitive drum 220. When the force-bearing part 112 on the rotatable part 116 receives the contact force and moves (e.g., along the contact direction D2), the first type of elastic member 410 is compressed. The first type of elastic member 410 may be disposed at one end or both ends of the rotatable part 116 in the first direction, and the two ends of the first type of elastic member 410 may also abut against other positions on the photosensitive frame 210 or the rotatable part 116, as long as it may be ensured that the first type of elastic member 410 can apply a separation force to the rotatable part 116.

When the processing cartridge is mounted in the electronic imaging device but no developing work is performed, the drum unit 200 is against the components in the electronic imaging device and is in a stationary state. The developing bearing 102 and the powder bin 115 are also in a relatively stationary state. The rotatable part 116 is in the second position under the action of the separation force of the first type of elastic member 410, and the developing roller 120 and the photosensitive drum 220 are in a separated state.

When developing is required, the force-applying member of the electronic imaging device moves and contacts the force-bearing part 112, and applies a contact force along the contact direction D2 to the force-bearing part 112. The contact force acts on the entire rotatable part 116, and overcomes the separation force of the first type of elastic member 410 under the action of the contact force, so that the first type of elastic member 410 is compressed and deformed. The rotatable part 116 rotates from the second position to the first position in the counterclockwise direction (i.e., contact direction D2) around the rotation center, and the developing roller 120 contacts the photosensitive drum 220. The contact force is greater than the separation force of the first type of elastic member 410. The developing roller 120 and the photosensitive drum 220 remain in contact, and the developing work may be performed. During the movement of the rotatable part 116, the powder bin 115 remains stationary, and when the rotatable part 116 rotates, the flexible member 117 will deform.

When the developing work is completed, the contact force of the force-applying member of the electronic imaging device is removed, the elastic deformation of the first type of elastic member 410 is restored. The generated separation force pushes the rotatable part 116 to rotate from the first position to the second position in a clockwise direction (i.e., separation direction D1) around the rotation center. The developing roller 120 is separated from the photosensitive drum 220 and is maintained in a drum-roller separation state under the action of the separation force, waiting for a next developing work to start or for the developing cartridge to be removed from the electronic imaging device.

The solution of the disclosed embodiment divides the developing frame 110 into two parts: a rotatable part 116 and a powder bin 115. The two parts are connected by a flexible member 117. The powder bin 115 is fixed, and the rotatable part 116 may move relative to the powder bin 115 under the expansion and contraction of the flexible member 117 to achieve contact and separation of the drum and roller. The flexible member 117 is used to avoid wear caused by rigid contact. The force required to replace the overall movement of the developing frame 110 with the movement of the rotatable part 116 is relatively small, thereby improving the flexibility of contact and separation of the drum and roller.

As shown in FIGS. 47, 49 and 52, the developing coupling 320 is configured to mesh with the developing drive head of the electronic imaging device and receive the driving force to drive the powder feeding roller 130 to rotate. During the movement of the rotatable part 116 between the second position and the first position, the powder feeding roller 130 as the rotation center will not change its position. The developing coupling 320 coaxially disposed with the powder feeding roller 130 will not change its position during the contact/separation process. That is, the developing coupling 320 just rotates but does not move its position during the operation. The first idler gear 370 meshes with the powder feeding roller gear 350, the developing roller gear 340 and the second idler gear 380 respectively, and the second idler gear 380 also meshes with the stirring frame gear 360. The developing coupling 320 receives the driving force to drive the powder feeding roller 130 and the powder feeding roller gear 350 to rotate synchronously. The powder feeding roller gear 350 transmits the driving force through the meshing relationship of the gears, thereby rotating the developing roller 120 and the stirring frame 140, and the developing unit 100 may work. When the developing operation is completed, the rotatable part 116 drives the developing roller 120 to rotate from the first position to the second position. When the developing roller 120 is separated from the photosensitive drum 220, the developing roller gear 340 is disengaged from the first idler gear 370.

The other structures of the processing cartridge of Embodiment 10 are identical to those of Embodiment 1 and will not be described again.

Beneficial effects of the present disclosure: a processing cartridge according to the embodiments of the present disclosure is provided with a control structure, which may limit the movement of the developing unit along the separation direction under the action of the self-gravity of the developing unit, so that the drum and roller of the processing cartridge cannot be separated by the self-gravity, thereby reducing the impact between the contact structures of the developing frame and the photosensitive frame, and extending the service life of the processing cartridge.

The above are merely some embodiments of the present disclosure. For those skilled in the art, several modifications and improvements may be made without departing from the creative concept of the present disclosure, which should belong to the protection scope of the present disclosure.

What is claimed is:

1. A processing cartridge, detachably mounted in an electronic imaging device, comprising:
a drum unit, including a photosensitive frame, on which a photosensitive drum is rotatably supported, wherein the photosensitive drum extends along a first direction;
a developing unit, including a developing frame, on which a developing roller is rotatably supported, wherein the developing roller extends along the first direction, wherein:
the developing unit is pivotally connected to the drum unit, and the developing unit is able to move around a rotation axis relative to the drum unit between a first position and a second position,
when in the first position, the developing roller is in contact with the photosensitive drum, and when in the second position, the developing roller is separated from the photosensitive drum, and
a direction of movement from the first position to the second position is a separation direction, and a direction of movement from the second position to the first position is a contact direction; and
a control structure, configured to limit a movement of the developing unit along the separation direction under an action of a self-gravity of the developing unit.

2. The processing cartridge according to claim 1, further comprising a separator, the separator being configured to provide or receive a separation force to move the developing unit from the first position to the second position along the separation direction.

3. The processing cartridge according to claim 2, wherein the separator is a first type of elastic member, and the first type of elastic member is disposed between the photosensitive frame and the developing frame.

4. The processing cartridge according to claim 2, wherein the developing unit and the drum unit are swingably connected via the control structure, and a center of the control structure is the rotation axis of the developing unit.

5. The processing cartridge according to claim 4, wherein the control structure is provided at a position close to an end of the developing frame in the separation direction.

6. The processing cartridge according to claim 5, wherein:
the developing roller and the photosensitive drum are disposed opposite to each other in a second direction intersecting the first direction, and a direction from the developing roller to the photosensitive drum is a positive side of the second direction; and
a connecting part is disposed on a negative side of the developing roller in the second direction.

7. The processing cartridge according to claim 6, wherein a straight line passing through the center of the control structure and parallel to the second direction is defined as a first straight line, the first straight line divides the processing cartridge into a first region and a second region, the developing roller and the photosensitive drum are located in the first region, and an area of the first region is larger than an area of the second region.

8. The processing cartridge according to claim 6, wherein a straight line passing through the center of the control structure and parallel to a third direction intersecting the first direction and the second direction is defined as a second straight line, and the second straight line divides the processing cartridge into a third region and a fourth region, the developing roller and the photosensitive drum are located in the third region, and an area of the third region is larger than an area of the fourth region.

9. The processing cartridge according to claim 2, wherein the separator is movably disposed at one end or both ends of the processing cartridge in the first direction, and the separator is able to receive the separation force to drive the developing unit to move along the separation direction.

10. The processing cartridge according to claim 9, wherein the separator does not protrude from an end of the processing cartridge in a third direction intersecting the first direction.

11. The processing cartridge according to claim 9, wherein the separator includes an abutment part extending along the first direction, the abutment part abuts against a separation control member of the electronic imaging device and receives the separation force, and drives the developing unit to swing along the separation direction, thereby separating the photosensitive drum and the developing roller.

12. The processing cartridge according to claim 1, wherein:
the control structure includes a limiting part and a limited part; and
the limiting part is disposed on the photosensitive frame, the limited part is disposed on the developing frame, the limited part abuts against the limiting part so that the movement of the developing unit along the separation direction is limited under the action of the self-gravity of the developing unit, and the developing roller keeps in contact with the photosensitive drum.

13. The processing cartridge according to claim 12, wherein:
one of the limiting part and the limited part is a limiting hole, and another one of the limiting part and the limited part is a limiting column, and the limiting column is able to move in the limiting hole; and
when the developing unit moves in the separation direction due to the self-gravity of the developing unit, the limiting column abuts against one end of the limiting hole away from the photosensitive drum, thereby reducing an impact between the developing roller and the photosensitive drum.

14. The processing cartridge according to claim 12, wherein:
the limiting part is a first rib, the limited part is a second rib, and the second rib is movable relative to the first rib; and
when the developing unit moves along the separation direction due to the self-gravity of the developing unit, the first rib abuts against the second rib to reduce an impact between the developing roller and the photosensitive drum.

15. The processing cartridge according to claim 12, wherein:
one of the limiting part and the limited part is a limiting protrusion, and another one of the limiting part and the limited part is an abutment surface, and the limiting protrusion is able to move relative to the abutment surface; and
when the developing unit moves in the separation direction due to the self-gravity of the developing unit, the limiting protrusion contacts the abutment surface to reduce an impact between the developing roller and the photosensitive drum.

16. The processing cartridge according to claim 12, wherein:
the developing unit further includes a force-bearing part for receiving a contact force of the electronic imaging device, when the force-bearing part receives the contact force, there is a gap between the limited part and the limiting part, and the developing roller is in close contact with the photosensitive drum; and
when the contact force is removed, and the developing unit moves in the separation direction relative to the drum unit due to the self-gravity of the developing unit, the limited part abuts against the limiting part to limit a swinging range of the developing unit, so that the developing roller maintains non-close contact with the photosensitive drum.

17. The processing cartridge according to claim 15, wherein the developing frame is provided with an arc portion, the photosensitive frame is provided with a limiting opening, and an arc outer surface of the arc portion abuts against an inner wall of the limiting opening.

18. The processing cartridge according to claim 17, wherein, under a cooperation of the limiting protrusion and the abutment surface, the arc portion and the limiting opening, the developing unit is not able to swing relative to the drum unit, and the developing roller and the photosensitive drum are kept in close contact.

19. The processing cartridge according to claim 1, wherein the control structure includes a pressing member, which is protruded from the developing frame, and when the processing cartridge is mounted in the electronic imaging device, the pressing member is able to cooperate with the electronic imaging device to move the developing unit along the contact direction and maintain the developing unit in the first position.

20. The processing cartridge according to claim 19, wherein the pressing member includes a pressing portion and a buffer portion, the pressing portion abuts against the electronic imaging device, and the buffer portion is disposed between the pressing portion and the developing frame to generate a buffer region therebetween.
